(19) United States
(12) Patent Application Publication
(10) Pub. No.: US 2025/0062876 A1
(43) Pub. Date: Feb. 20, 2025

(54) COMMUNICATION METHOD, DEVICE, STORAGE MEDIUM, AND CHIP

(71) Applicant: GUANGDONG OPPO MOBILE TELECOMMUNICATIONS CORP., LTD., Dongguan (CN)

(72) Inventors: Zhihua SHI, Dongguan (CN); Jianfei CAO, Dongguan (CN); Yun FANG, Dongguan (CN)

(21) Appl. No.: 18/936,892

(22) Filed: Nov. 4, 2024

Related U.S. Application Data
(63) Continuation of application No. PCT/CN2022/111232, filed on Aug. 9, 2022.

(51) Int. Cl. H04L 5/00

(52) U.S. Cl. CPC H04L 5/0053; H04L 5/0035; H04L 5/0096

(57) ABSTRACT

A communication method, device, a storage medium, and a chip are provided. The method includes: according to one or more transmission configuration indication (TCI) states, a terminal device sends a physical uplink shared channel (PUSCH) corresponding to a configured grant (CG).

### CROSS-REFERENCE TO RELATED APPLICATION

The present disclosure is a continuation application of International Application No. PCT/CN2022/111232 filed on Aug. 9, 2022. The disclosure of the above application is hereby incorporated by reference in its entirety.

### BACKGROUND

The 5G New Radio (NR) system supports the transmission and reception of multiple Transmission Reception Points (TRPs) to expand coverage to higher bands. Multiple communication links may be formed between network devices having multiple TRPs and/or terminal devices having multiple panels to increase throughput and/or provide additional diversity gains.

### SUMMARY

Embodiments of the present disclosure relate to the field of mobile communication technology, and more particularly, to a communication method, an apparatus, a device, a storage medium, a chip, a product, and a program. Embodiments of the present disclosure provide a communication method, an apparatus, a device, a storage medium, a chip, a product, and a program.

In a first aspect, an embodiment of the present disclosure provides a communication method. The method includes the following operation.

A terminal device transmits a Physical Uplink Shared Channel (PUSCH) corresponding to a Configured Grant (CG) according to one or more Transmission Configuration Indicator (TCI) states.

In a second aspect, an embodiment of the present disclosure provides a communication method. The method includes the following operation.

A network device receives a PUSCH corresponding to a CG. The PUSCH corresponding to the CG is transmitted according to one or more TCI states.

In a third aspect, an embodiment of the present disclosure provides a communication apparatus. The communication apparatus includes a communication unit.

The communication unit is configured to transmit a PUSCH corresponding to a CG according to one or more TCI states.

In a fourth aspect, an embodiment of the present disclosure provides a communication apparatus. The communication apparatus includes a communication unit.

The communication unit is configured to receive a PUSCH corresponding to a CG. The PUSCH corresponding to the CG is transmitted according to one or more TCI states.

In a fifth aspect, an embodiment of the present disclosure provides a communication device. The communication device includes a processor and a memory.

The memory is configured to store a computer program executable on the processor.

The processor is configured to implement the method of the first aspect or the second aspect when executing the program.

In a sixth aspect, an embodiment of the present disclosure provides a computer storage medium having stored thereon one or more programs, and the one or more programs are executable by one or more processors to implement the method of the first aspect or the second aspect.

In a seventh aspect, an embodiment of the present disclosure provides a chip including a processor for invoking and running a computer program from a memory to implement the method of the first aspect or the second aspect.

In an eighth aspect, an embodiment of the present disclosure provides a computer program product that includes a computer storage medium having stored thereon a computer program. The computer program includes instructions executable by at least one processor. When executed by the at least one processor, the instructions implement the method of the first aspect or the second aspect.

In a ninth aspect, an embodiment of the present disclosure provides a computer program that causes a computer to perform the method of the first aspect or the second aspect.

### BRIEF DESCRIPTION OF THE DRAWINGS

The accompanying drawings described herein are intended to provide a further understanding of the present disclosure, and constitute a part of the present disclosure. The schematic embodiments of the present disclosure and the description thereof are intended to explain the present disclosure, and do not constitute an undue limitation of the present disclosure.

FIG. 1 is a diagram of an application scenario according to an embodiment of the present disclosure.

FIG. 2 is a diagram of multi-TRP transmission according to an embodiment of the present disclosure.

FIG. 3 is a diagram of multi-beam transmission according to an embodiment of the present disclosure.

FIG. 4 is a diagram of a method for configuring a TCI state of a PDSCH according to an embodiment of the present disclosure.

FIG. 5 is a flow diagram of a communication method according to an embodiment of the present disclosure.

FIG. 6 is a flow diagram of another communication method according to an embodiment of the present disclosure.

FIG. 7 is a diagram of a structural composition of a communication apparatus according to the embodiment of the present disclosure.

FIG. 8 is a diagram of a structural composition of another communication apparatus according to the embodiment of the present disclosure.

FIG. 9 is a structural diagram of a communication device according to an embodiment of the present disclosure.

FIG. 10 is a structural diagram of a chip according to an embodiment of the present disclosure.

### DETAILED DESCRIPTION

In the art, how to perform uplink transmission by the terminal device has been a concern for a long time. In the embodiments of the present disclosure, the terminal device transmits the PUSCH corresponding to the CG according to one or more TCI states. In this way, since the transmission of the PUSCH corresponding to the CG performed by the terminal device is based on one or more TCI states, the terminal device can efficiently transmit the PUSCH corresponding to the CG, and the reliability of transmission of the PUSCH corresponding to the CG can be improved.

Hereinafter, the technical solutions in the embodiments of the present disclosure would be described with reference to the accompanying drawings of the embodiments of the present disclosure. It is apparent that the described embodiments are part of the embodiments of the present disclosure, but not all of the embodiments. Based on the embodiments of the present disclosure, all other embodiments obtained by those skilled in the art without creative work fall within the scope of protection of the present disclosure.

The technical solutions described in the embodiments of the present disclosure may be arbitrarily combined without conflict. In the description of the present disclosure, “a plurality of” means two or more unless otherwise explicitly and specifically defined.

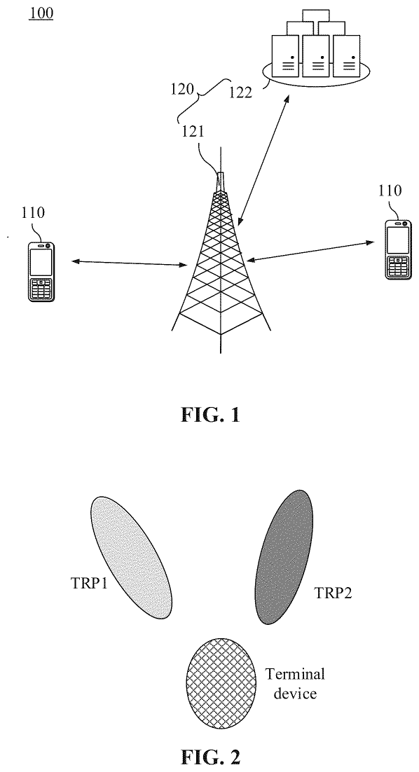

FIG. 1 is a diagram of an application scenario according to an embodiment of the present disclosure. As illustrated in FIG. 1, the communication system 100 may include a terminal device 110 and a network device 120. The network device 120 may communicate with the terminal device 110 through an air interface. Multi-service transmission is supported between the terminal device 110 and the network device 120.

It should be understood that the embodiments of the present disclosure are only illustrated with reference to the communication system 100, but the embodiments of the present disclosure are not limited thereto. That is, the technical solutions of the embodiments of the present disclosure may be applied to various communication systems, such as a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of a NR system, a LTE-based access to unlicensed spectrum (LTE-U) system, an NR-based access to unlicensed spectrum (NR-U) system, a Universal Mobile Telecommunication System (UMTS), a Wireless Local Area Networks (WLAN), a Wireless Fidelity (WiFi), a LTE Time Division Duplex (TDD), a Universal Mobile Telecommunication System (UMTS), an Internet of Things (IoT) system, a Narrow Band Internet of Things (NB-IoT) system, an enhanced Machine-Type Communication (eMTC) system or future communication systems (for example, 6G and 7G communication systems).

The network device 120 in the embodiments of the present disclosure may include an access network device 121 and/or a core network device 122. The access network device may provide communication coverage for a particular geographic area and may communicate with the terminal device 110 (for example, a User Equipment (UE)) located within that coverage area.

The terminal device in the present disclosure is a device with wireless communication function. The terminal device may be deployed on land (e.g., indoor or outdoor, handheld or vehicle-mounted). The terminal device may also be deployed on the water (e.g., on a ship, etc.). The terminal device may also be deployed in the air (e.g., in an aircraft, in a balloon and in a satellite, etc.). The terminal device in the present disclosure may be referred to as a User Equipment (UE), a Mobile Station (MS), a Mobile Terminal (MT), a subscriber unit, a subscriber station, a mobile platform, a remote station, a remote terminal, a mobile device, a user terminal, a terminal, a wireless communication device, a user agent, or a user device. The terminal device may include one or a combination of at least two of the following: an Internet of Things (IoT) device, a satellite terminal, a Wireless Local Loop (WLL) station, a Personal Digital Assistant (PDA), a handheld device with a wireless communication function, a computing device or other processing devices connected to wireless modems, a server, a mobile phone, a tablet (Pad), a computer with a wireless transceiver function, a handheld computer, a desktop computer, a PDA, a portable media player, a smart speaker, a navigation device, a smart watch, smart glasses, a smart necklace and other wearable devices, a pedometer, a digital TV, a Virtual Reality (VR) terminal device, an Augmented Reality (AR) terminal device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, a vehicle in the Internet of Vehicle, a vehicle-mounted device and a vehicle-mounted module in an internet of vehicles, a wireless modem, a handheld device, a Customer Premise Equipment (CPE), or a smart appliance, etc. Alternatively, the terminal device 110 may be any terminal device, which may include, but is not limited to, a terminal device that uses a wired or wireless connection to the network device 120 or other terminal devices. Alternatively, the terminal device 110 may be used for Device-to-Device (D2D) communication.

The access network device 121 may include one or a combination of at least two of the following: an Evolutional Node B (eNB or eNodeB) in a Long Term Evolution (LTE) system, a Next Generation Radio Access Network (NG RAN) device, a base station (gNB) in the NR system, a small station, a micro station, a wireless controller in Cloud Radio Access Network (CRAN), an access point of Wireless-Fidelity (Wi-Fi), a transmission reception point (TRP), a relay station, an access point, a vehicle-mounted device, a wearable device, a hub, a switch, a bridge, a router, or a network device in the future evolutional Public Land Mobile Network (PLMN), etc. In any embodiment of the present disclosure, the TRP may be a transmission/reception point.

The core network device 122 may be a 5G Core (5GC) device, and may include one or a combination of at least two of the following: an Access and Mobility Management Function (AMF), an Authentication Server Function (AUSF), a User Plane Function (UPF), a Session Management Function (SMF), a Location Management Function (LMF) or a Policy Control Function (PCF). In other embodiments, the core network device may also be an Evolved Packet Core (EPC) device of the LTE network, for example, a Session Management Function+Core Packet Gateway (SMF+PGW-C) device. It should be understood that the SMF+PGW-C may simultaneously implement functions of the SMF and the PGW-C. In the process of network evolution, the above core network device 122 may be called by another name, or a new network entity may be formed by dividing the functions of the core network, which is not limited by the embodiments of the present disclosure.

The connection among respective functional units in the communication system 100 may be established through a Next Generation (NG) network interface to implement communication.

For example, the terminal device may establish an air interface connection with the access network device through the NR interface to transmit the user plane data and the control plane signaling. The terminal device may establish a control plane signaling connection with the AMF through the NG interface 1 (N1). The access network device, such as a next generation radio access base station (gNB), may establish a user plane data connection with the UPF through an NG interface 3 (N3). The access network device may establish a control plane signaling connection with the AMF through the NG interface 2 (N2). The UPF may establish a control plane signaling connection with the SMF through the NG interface 4 (N4). The UPF may interact user plane data with the data network through the NG interface 6 (N6). The AMF may establish a control plane signaling connection with the SMF through the NG interface 11 (N11). The SMF may establish a control plane signaling connection with the PCF through the NG interface 7 (N7).

FIG. 1 exemplarily illustrates one base station, one core network device and two terminal devices. Alternatively, the wireless communication system 100 may include multiple base stations and other numbers of terminal devices may be included within the coverage area of each base station, which is not limited in the embodiments of the present disclosure.

It should be noted that FIG. 1 only illustrates a system applicable to the present disclosure in the form of an example, and of course, the method shown in the embodiments of the present disclosure may also be applied to other systems. Furthermore, the terms “system” and “network” are often interchangeably used herein. Herein, the term “and/or” is only used for describing an association relationship between association objects, which means that there may be three relationships. For example, A and/or B, which may mean that A exists alone, A and B simultaneously exist, or B exists alone. In addition, the character “/” in the present disclosure generally indicates that there is an “or” relationship between the associated objects. It should also be understood that the “indication” mentioned in the embodiments of the present disclosure may indicate a direct indication, an indirect indication, or describe an associated relationship. For example, A indicates B, which may mean that A directly indicates B (for example, B may be acquired through A). It may also mean that A indicates B indirectly (for example, A indicates C, and B may be acquired through C). It may also indicate that there is an association relationship between A and B. It should also be understood that “correspondence” mentioned in the embodiments of the present disclosure may indicate that there is a direct correspondence or indirect correspondence between the two objects, may indicate that there is an associated relationship between the two objects, or may indicate a relationship of indicating and being indicated, configuring and being configured, or the like. It should also be understood that the “predefined”, “stipulation”, “predetermined”, or “predefined rule” mentioned in the embodiments of the present disclosure may be implemented by storing corresponding codes, tables, or other manners that may be used to indicate relevant information in advance in devices (including, for example, the terminal device and the network device), and the specific implementations are not limited in the present disclosure. For example, “predefined” may refer to be defined in the protocol. It should also be understood that in the embodiment of the present disclosure, the “protocol” may refer to a standard protocol in the field of communication, which may include, for example, an LTE protocol, an NR protocol, and related protocols applied to future communication systems, which is not limited in the present disclosure.

In order to facilitate understanding of the technical solutions of the embodiments of the present disclosure, the related technologies of the embodiments of the present disclosure would be described below. The related technologies below may be arbitrarily combined with the technical solutions of the embodiments of the present disclosure as optional solutions, and all of them belong to the scope of protection of the embodiments of the present disclosure.

The multi-beam system is described below.

The design objectives of the NR/5G system include large bandwidth communication of high bands (such as bands above 6 GHz). When the operating frequency becomes higher, the path loss in the transmission process would increase, which may affect the coverage ability of the high-frequency system. In order to effectively ensure the coverage of the high-frequency band NR systems, an effective technical solution is to use multiple beams or hybrid beam technology based on massive antenna arrays or massive multiple-input multiple-output (MIMO, Massive MIMO) to improve the coverage capabilities.

In the existing typical 2G/3G/4G system, a cell (sector) uses a wider beam to cover the entire cell. Therefore, at each time, the terminal device within the cell coverage area has the opportunity to obtain the transmission resources allocated by the system.

The multi-beam system of NR/5G covers the entire cell through different beams. That is, each beam covers a respective small area, and multiple beams cover the entire cell through the sweeping over time. At present, different beams are identified by different signals carried thereon.

Alternatively, different Synchronization Signal Blocks (SS blocks, or SSBs) are transmitted on some different beams, and the terminal device may distinguish different beams through different SS blocks. The SSB may also be referred to as a Synchronization Signal/Physical Broadcast Channel block (SS/PBCH block).

Alternatively, different Channel State Information-Reference Signals (CSI-RSs) are transmitted on some different beams, and the terminal device identifies different beams through the CSI-RS/CSI-RS resources.

Alternatively, these visible signals such as the SS block and/or CSI-RS may correspond to a certain one/some physical beams.

In a multi-beam system, a Physical Downlink Control Channel (PDCCH) and a Physical Downlink Shared Channel (PDSCH) may be transmitted through different downlink transmission beams.

For systems below 6G, there is generally no analog beam on the terminal device side. Therefore, an omnidirectional antenna (or a nearly omnidirectional antenna) is used to receive signals transmitted by different downlink transmission beams of the base station.

For millimeter wave systems, there may be analog beams on the terminal device side, and the corresponding downlink reception beams need to be used to receive signals transmitted by the corresponding downlink reception beams. At this time, corresponding beam indication information is needed to assist the terminal device in determining the information related to the transmission beam on the network side or the information related to the corresponding reception beam on the terminal device side.

In the NR protocol, the beam indication information does not directly indicate the beam itself, but the beam is indicated by Quasi-co-located or quasi-co-location (QCL) (‘QCL-TypeD’ type) between signals. On the terminal device side, it is determined to receive the corresponding channel/signal, which is also based on the QCL assumption. The QCL assumption is indicated by Transmission Configuration Indication (TCI) state (TCI-state). That is, the network configures and/or indicates the corresponding TCI-state through relevant signaling (for example, Radio Resource Control (RRC), and/or Medium Access Control Control Element (MAC CE), and/or Downlink Control Information (DCI)).

The following describes multi-TRP/panel/beam transmission.

The TRP transmission means that multiple TRPs can simultaneously communicate with a terminal device on the same carrier. Multiple TRPs, multiple panels or multiple beams simultaneously perform transmission with one terminal device in the NR system and the same solution may be adopted, which is often not distinguished in the description, and may be referred to as, for example, multiple TRP transmission, mTRP transmission, or M-TRP (multiple-TRP) transmission, or multi-TRP/panel/beam transmission.

In the related art, schemes in which multiple TRPs, multiple panels/antenna panels or multiple beams simultaneously transmit downlink data to the terminal device support the following two types of schemes.

A first scheme is single-PDCCH based scheme. The terminal device detects only one NR-PDCCH, and the DCI obtained by detecting the control channel PDCCH indicates indication information related to data simultaneously transmitted on multiple TRPs/panels/beams, so that one transmission corresponds to multiple TCI-states, that is, multi-TRP/panel/beam transmission is implicitly supported through multiple TCI-states.

In any embodiment of the present disclosure, TCI-state and TCI state are understood in the same way.

A second scheme is multiple-PDCCH based scheme. The terminal device receives different NR-PDCCHs from different TRPs/panels/beams, and the DCI obtained by detecting each control channel PDCCH indicates respective indication information related to data transmission, so that the Control Resource Set (CORESET) corresponding to the DCI scheduling the data may be associated with different CORESET pool numbers/indexes, that is, corresponding to different CORESET pool indexes. That is, multi-TRP/panel/beam transmission is implicitly supported through multiple different CORESET pool indexes.

FIG. 2 is a diagram of multi-TRP transmission according to an embodiment of the present disclosure. As illustrated in FIG. 2, the terminal device may receive information through TRP1 and/or TRP2.

FIG. 3 is a diagram of multi-beam transmission according to an embodiment of the present disclosure. As illustrated in FIG. 3, the network device may transmit information through beam 1 and beam 2.

For the first scheme, the terminal device only needs to detect one NR-PDCCH, and the detection complexity of the control channel may be lower than that of the second scheme. The first scheme requires the ability of quickly exchanging information between different panels/TRPs/beams.

For the second solution, the terminal device needs to detect multiple NR-PDCCHs on the same carrier simultaneously, which may increase the complexity, but may improve the flexibility and robustness.

The possible application scenarios of the second scheme at least include the following.

A first scenario: multiple TRPs belong to the same cell, and the connection (backhaul) between TRPs is ideal (that is, the information interaction may be performed quickly and dynamically).

A second scenario: multiple TRPs belong to the same cell, and the connection (backhaul) between TRPs is non-ideal (that is, the TRPs cannot quickly exchange information and may only perform relatively slow data interaction).

A third scenario: multiple TRPs belong to different cells, and the connection (backhaul) between TRPs is ideal.

A fourth scenario: multiple TRPs belong to different cells, and the connection (backhaul) between TRPs is non-ideal.

A fifth scenario: the TRPs in the above first to fourth scenarios are replaced with the beams, and four multi-beam application scenarios may be obtained correspondingly.

Alternatively, the first scheme is generally believed to be applicable only to scenarios where the connection (backhaul) is ideal (that is, the first scenario and the third scenario).

In the R16, only the multi-TRP transmission of downlink data transmission is studied and supported. In R17, the multi-TRP transmissions of the PDCCH, the PUSCH and the PUCCH are studied and supported to increase the reliability of corresponding channel transmissions.

Different from dynamically scheduling the PUSCH (for example, each PUSCH is dynamically scheduled by using the DCI), some parameters of a scheduling-free/Configured Grant (CG) PUSCH (that is, the dynamic scheduling is not required, and the DCI is not required for the dynamic scheduling) are configured through the RRC signaling, rather than being dynamically indicated by the DCI. Type1 CG PUSCH and Type2 CG PUSCH are supported in the NR. The Type1 CG PUSCH is semi-statically configured through the RRC with parameters needed for transmitting the PUSCH, which may include time-frequency domain resources, Demodulation Reference Signal (DMRS), open-loop power control, Modulation and Coding Scheme (MCS), etc. The Type2 CG PUSCH is configured through RRC with some semi-static parameters, which may include a period of the time-domain resource, the power control, the times of repetition, etc. The activation is performed by the DCI, and the time-frequency resources, DMRS, MCS and other parameters are indicated in the same DCI. Multi-TRP based enhancement is provided for both types of CG PUSCHs in R17. R17 stipulates that a set of P0-PUSCH-Alpha and powerControlLoopToUse are added to the ConfiguredGrantConfig for the power control of the second TRP. For the Type2 CG PUSCH, the original first set of power control values is associated with the first channel Sounding Reference Signal (SRS) resource set, and the second set of values is associated with the second SRS resource set. Using the first set of power control or the second set of power control, or using both the first set of power control and second set of power control depends on the 2-bit field newly added in the DCI that is used to indicate the dynamic switching between the single TRP and the multiple TRPs. For the Type1 CG PUSCH, a set of a pathlossReferenceIndex field, a srs-ResourceIndicator field and a precodingAndNumberOfLayers field is added in the rrc-ConfiguredUplinkGrant to indicate a path loss reference signal, a Reference Signal resource Indicator (SRI) and a Transmit PrecoderMetricIndicator (TPMI) corresponding to the second TRP. It should be emphasized that, unlike DCI signaling, which has a high overhead requirement, the RRC signaling has a relatively low overhead requirement, and thus the srs-ResourceIndicator field and the precodingAndNumberOfLayers field associated with the second SRS resource set indicated through the RRC occupy the same number of bits as the srs-ResourceIndicator field and the precodingAndNumberOfLayers field associated with the first SRS resource set.

In any embodiment of the present disclosure, the rrc-ConfiguredUplinkGrant may be translated into the rrc-configured uplink grant. The pathlossReferenceIndex may be translated into the path loss reference index. The srs-ResourceIndicator may be translated into the srs-resource indicator. The precodingAndNumberOfLayers may be translated into the precoding and number of layers.

In any embodiment of the present disclosure, configured grant, scheduling-free, and dynamic scheduling-free may be understood in the same way, or the Configured grant may be configured grant, scheduling-free or dynamic scheduling-free.

The Type 1CG PUSCH transmission is semi-statically configured to operate upon receiving a higher layer parameter configuredGrantConfig including the rrc-ConfiguredUplinkGrant without detecting the UL grant in the DCI. After receiving the higher layer parameter configuredGrantConfig that does not include the rrc-ConfiguredUplinkGrant, the Type 2 CG PUSCH transmission is semi-persistently scheduled by the UL grant in the valid activated DCI.

For the multi-TRP systems, the transmission schemes discussed above are all for the case of the same carrier. For example, for a multiple-PDCCH based PDSCH transmission scheme, the terminal device detects multiple pieces of DCI (for example, two pieces of DCI) on the same carrier. Each DCI may schedule a respective PDSCH, and the multiple PDSCHs are also on the same carrier. PDCCH transmission and/or uplink transmission (for example, PUSCH and/or PDCCH) are also on the same carrier or the same cell. The same is true for the uplink multi-TRP transmission, which is for the transmission on the same carrier.

The TCI state is described below.

When the terminal device receives signals, in order to improve the reception performance, the characteristics of the transmission environment corresponding to the data transmission may be used to improve the reception algorithm. For example, the statistical characteristics of the channel may be used to optimize the design and parameters of the channel estimator. In the NR system, these characteristics corresponding to the data transmission are represented through QCL states (QCL-Info).

If the downlink transmission is from different TRPs/panels/beams, the characteristics of the transmission environment corresponding to the data transmission may also change. Therefore, in the NR system, when the network side transmits the downlink control channel or data channel, the corresponding QCL state information would be indicated to the terminal device through the TCI state.

One TCI state may include the following configuration: a TCI state ID for identifying a TCI state, QCL Information 1, and QCL Information 2.

One piece of the QCL information further includes the following information.

QCL type configuration, which may be one of QCL type A, QCL type B, QCL type C, QCL type D.

QCL reference signal configuration, which may include a cell ID in which the reference signal is located, a Band Width Part (BWP) ID, and an identification of the reference signal (which may be a CSI-RS resource ID or an SSB index).

If both the QCL information 1 and the QCL information 2 are configured, the QCL type of at least one piece of QCL information is one of typeA, typeB, and typeC, and the QCL type of the other piece of QCL information (if configured) is QCL type D.

The definitions of different QCL type configurations are as follows.
‘QCL-TypeA’: {Doppler shift, Doppler spread, average delay, delay spread}.
‘QCL-TypeB’: {Doppler shift, Doppler spread}.
‘QCL-TypeC’: {Doppler shift, average delay}.
‘QCL-TypeD’: {Spatial Rx parameter}.

In the NR system, the network side may indicate a respective TCI state for a downlink signal or a downlink channel.

If the network side configures the QCL reference signal of the target downlink channel or the target downlink signal as the reference SSB or the reference CSI-RS resource through the TCI state, and the QCL type is configured as typeA, typeB, or typeC, the terminal device may assume that the large-scale parameters of the target downlink signal is the same as the large-scale parameters of the reference SSB or the reference CSI-RS resource are the same, and the large-scale parameters are determined by the QCL type configuration.

Similarly, if the network side configures the QCL reference signal of the target downlink channel or the downlink signal as the reference SSB or the reference CSI-RS resource through the TCI state, and the QCL type is configured as typeD, the terminal device may receive the target downlink signal by using the same reception beam (i.e., the Spatial Rx parameter) as the reception beam of the reference SSB or the reference CSI-RS resource. Typically, the target downlink channel (or downlink signal) and its reference SSB or reference CSI-RS resource are transmitted on the network side through the same TRP or the same panel or the same beam. If the transmission TRPs or transmission panels or transmission beams of two downlink signals or downlink channels are different, different TCI states are usually configured.

For the downlink control channel, the TCI state corresponding to the CORESET may be indicated through RRC signaling or RRC signaling+Medium Access Control (MAC) signaling.

For the downlink data channel, the available TCI state set is indicated by RRC signaling, and some of the TCI states are activated through MAC layer signaling. Finally one or two TCI states are indicated from the activated TCI states through the TCI state indication field in the DCI for the PDSCH scheduled by the DCI. The case of 2 TCI states is mainly for multi-TRP similar scenarios.

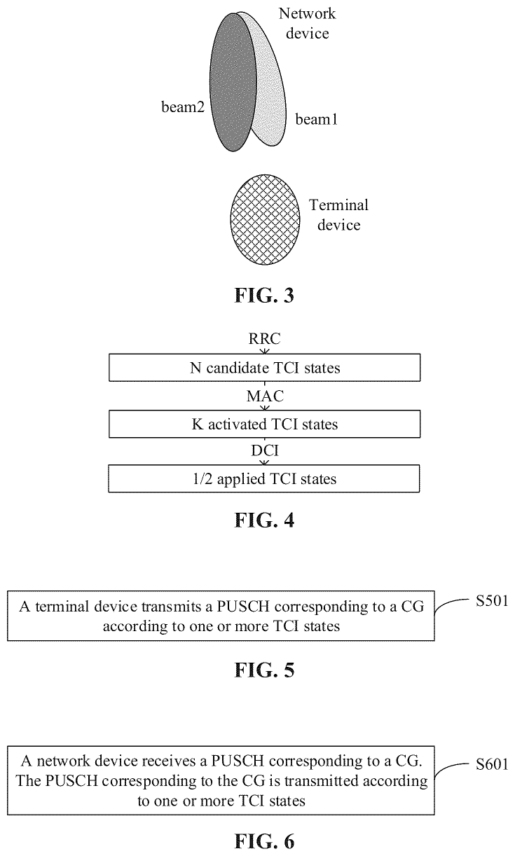

FIG. 4 is a diagram of a method for configuring a TCI state of a PDSCH according to an embodiment of the present disclosure. As illustrated in FIG. 4, N candidate TCI states may be determined through the RRC signaling. For example, the RRC signaling may indicate N candidate TCI states. K activated TCI states may be determined from N candidate TCI states through the MAC signaling. One or two used TCI states may be determined from the K activated TCI states through the DCI signaling.

The Unified TCI state is described below.

The indication mechanism of the TCI state is introduced in R15, which is only applicable to downlink channels and signals, and has many limitations in the application in the NR system. In order to provide a more unified uplink and downlink beam management mechanism for the NR system, based on the design of Rel. 15/16 TCI state, 3GPP Rel.17 proposes the concept of the unified TCI state, which adds important new functions. Examples are as follows.

Two modes of unified TCI state are designed.

A first mode contains one type of TCI state, which may be applicable to uplink and downlink channels and signals. This type of TCI state may be referred to as a joint TCI state.

A second mode contains two types of TCI states. The DL TCI state is only applicable to downlink channels and signals, and the UL TCI state is only applicable to the uplink channels and signals.

The downlink channel (partial PDCCH, PDSCH) and the signal (aperiodic CSI-RS) use the same downlink transmission indication beam, and use the DL TCI state or the joint TCI state.

The uplink channel (PUCCH, PUSCH) and the signal (SRS) use the same uplink transmission beam, and use the UL TCI state or the joint TCI state.

The unified TCI state may be dynamically updated and indicated by using the MAC CE and/or the DCI.

The unified TCI state is applicable to the carrier aggregation scenario, and the beam indication on a single Component Carrier (CC) may be applicable to multiple different CCs.

The uplink beam indication may be simultaneously given with the uplink power control parameter through the UL TCI state or the joint TCI state.

The unified TCI state supports the beam management function between cells.

For the CORESET on each CC, it may be roughly divided into the following four types in the discussion of 3GPP.

CORESET A: It is only associated with the search space exclusive to the terminal device, so it can be considered as the downlink control channel resource exclusive to the terminal device, and should follow the indicated unified TCI state(s).

CORESET B: It is only associated with the common search space of the cell. Whether it can follow the unified TCI state(s) indicated by the Network (NW) depends on the RRC configuration of the NW.

CORESET C: It is associated with the search space exclusive to the terminal device and the search space common to the cell. Whether it can follow the unified TCI state(s) indicated by the NW depends on the RRC configuration of the NW.

CORESET 0: It must be associated with the common search space of the cell, and may also be associated with the search space exclusive to the terminal device. Whether it can follow the unified TCI state(s) indicated by the NW depends on the RRC configuration of the NW.

In the unified TCI state mechanism of R17, the scenario of multi-TRP transmission is not considered, and only the single-TRP scenario is supported.

The TCI state in the embodiments of the present disclosure includes any of the aforementioned TCI states if the TCI state is not explicitly specified. For example, the TCI state may be a joint TCI state, a separate TCI state, a DL TCI state, a UL TCI state, or a combination thereof (That is, multiple different types of TCI states, such as at least one of the DL TCI state, the UL TCI state, the joint TCI state or the separate TCI state are included). If the RRC parameter TCI-state is used, it generally refers to the DL TCI state and/or the joint TCI state. If the RRC parameter DLorJointTCIState is used, it generally refers to the DL TCI state and/or the joint TCI state. If the RRC parameter UL-TCIState or TCI-UL-State or UL-TCI-State is used, it is generally referred to as the UL TCI state.

However, there is still a lack of perfect scheme and specific details about how to configure and indicate a unified TCI state in the multi-TRP transmission system.

In order to facilitate understanding of the technical solutions of the embodiments of the present disclosure, the technical solutions of the present disclosure would be described in detail below with reference to specific examples. The above related technologies, as optional solutions, may be arbitrarily combined with the technical solutions of the embodiments of the present disclosure, and all of them fall within the scope of protection of the embodiments of the present disclosure. Embodiments of the present disclosure include at least some of the following contents.

FIG. 5 is a flow diagram of a communication method according to an embodiment of the present disclosure. As illustrated in FIG. 5, the method includes the following operation.

In operation S501, a terminal device transmits a PUSCH corresponding to a CG according to one or more TCI states.

FIG. 6 is a flow diagram of another communication method according to an embodiment of the present disclosure. As illustrated in FIG. 6, the method includes the following operation.

In operation S601, a network device receives a PUSCH corresponding to a CG. The PUSCH corresponding to the CG is transmitted according to one or more TCI states.

Alternatively, in other embodiments of the present disclosure, the PUSCH corresponding to the CG may be replaced with the PUSCH or other PUSCH.

Alternatively, the TCI state according to which the terminal device transmits the PUSCH corresponding to the CG may be a unified TCI state.

Alternatively, the terminal device may determine the spatial relationship or the uplink transmission spatial filter of the PUSCH corresponding to the one or more TCI states according to the one or more TCI states, and transmit the PUSCH corresponding to the CG based on the spatial relationship or the uplink transmission spatial filter of the PUSCH corresponding to the one or more TCI states.

In any embodiment of the present disclosure, the transmission may include sending or receiving unless otherwise specified. Specifically, the transmission is sending or receiving, which may be determined according to the semantics of the context, and would not be repeatedly described in the present disclosure.

Alternatively, the network device receives the PUSCH corresponding to the CG according to the one or more TCI states. Alternatively, the network device may determine the spatial relationship or the uplink transmission spatial filter of the PUSCH corresponding to the one or more TCI states according to the one or more TCI states, and receive the PUSCH corresponding to the CG based on the spatial relationship or the uplink transmission spatial filter of the PUSCH corresponding to the one or more TCI states.

Alternatively, the terminal device may transmit the PUSCH corresponding to the CG according to the uplink TCI state available for the uplink transmission. Alternatively, the network device may receive the PUSCH corresponding to the CG according to the uplink TCI state available for the uplink transmission.

The PUSCH corresponding to the CG in any embodiment of the present disclosure may include PUSCHs corresponding to one or more CGs. Alternatively, each CG corresponds to a respective PUSCH.

The PUSCH corresponding to the CG in any embodiment of the present disclosure may be understood in the same manner as the PUSCH of the CG or CG PUSCH.

The sending/receiving of the PUSCH corresponding to the CG in any embodiment of the present disclosure may include repetition of the sending/receiving of the PUSCH corresponding to the CG, or single sending/receiving of the PUSCH corresponding to the CG.

In the embodiments of the present disclosure, the terminal device transmits the PUSCH corresponding to the CG according to one or more TCI states. In this way, since the transmission of the PUSCH corresponding to the CG performed by the terminal device is based on one or more TCI states, the terminal device can efficiently transmit the PUSCH corresponding to the CG, and the reliability of transmission of the PUSCH corresponding to the CG can be improved.

In some embodiments, the method further includes the following operation.

The terminal device receives first information. The first information is configured to indicate the CG.

In some embodiments, the method further includes the following operation.

The network device transmits first information. The first information is configured to indicate the CG.

In some embodiments, the CG may be referred to as Configured Grant Configuration or CG configuration information in other embodiments.

Alternatively, the terminal device receives first information transmitted by the network device. The first information is configured to indicate one or more CGs.

Alternatively, the first information may indicate one or more configuration grants on one BWP.

Alternatively, the type of the CG is a CG Type 1 or a CG Type 2.

Alternatively, when the type of CG is CG Type 1, for the CG, the first information further includes rrc-ConfiguredUplinkGrant in the RRC parameter configuredGrantConfig.

In some embodiments, the method further includes the following operation.

The terminal device receives second information. The second information is configured to indicate that the PUSCH corresponding to the CG is transmitted according to one or more TCI states. For example, the second information is configured to indicate that the PUSCH corresponding to the CG is transmitted according to multiple TCI states, or the PUSCH corresponding to the CG is transmitted according to one or more TCI states, or the PUSCH corresponding to the CG is transmitted according to one TCI state.

In some embodiments, the method further includes the following operation.

The network device transmits the second information. The second information is configured to indicate that the PUSCH corresponding to the CG is transmitted according to one or more TCI states. For example, the second information is configured to indicate that the PUSCH corresponding to the CG is transmitted according to multiple TCI states, or the PUSCH corresponding to the CG is transmitted according to one or more TCI states, or the PUSCH corresponding to the CG is transmitted according to one TCI state.

Alternatively, the terminal device receives the second information transmitted by the network device.

Alternatively, the second information may be referred to as CG indication information or first CG indication information in other embodiments. Alternatively, the second information may also be referred to as specific indication information or predetermined indication information. The second information may be any information transmitted by the network device to the terminal device. Alternatively, in other embodiments of the present disclosure, the second information may be information preconfigured by the terminal device.

Alternatively, the second information is configured to indicate that the TCI state according to which the PUSCH corresponding to the CG is transmitted may be a unified TCI state.

Alternatively, different second information indicates that the PUSCH corresponding to the CG is transmitted according to a different number of TCI states. Alternatively, the different second information indicates that the PUSCH corresponding to the CG is transmitted according to the same number of TCI states.

In some embodiments, the CG corresponds to one BWP. In other embodiments, the CG corresponds to all CGs on a serving cell, a serving cell group or a band.

In some embodiments, the second information is for all CGs on one BWP.

In other embodiments, the second information is for all CGs on a serving cell, a serving cell group or a band.

In yet other embodiments, the second information is for one CG.

Alternatively, the second information is for all CGs on one BWP. That is, the content indicated by the second information is applicable to all CGs on one BWP, so that the signaling overhead can be reduced by providing one piece of indication information for all CGs on the BWP.

Alternatively, the second information is for all CGs on a serving cell, a serving cell group, or a band. That is, the content indicated by the second information is applied to all CGs on a serving cell, so that the signaling overhead can be reduced by giving one piece of indication information to all CGs on a serving cell/serving cell group/band.

Alternatively, the second information is for one CG, that is, one CG has its corresponding second information, and the other CG has its corresponding second information, so that by separately indicating the second information for each CG, independent indication can be performed for different CGs, thereby increasing the flexibility of network configuration and providing a larger space for further optimization. For example, the second information includes the first target information and the second target information, the CG indicated by the first information includes the first CG and the second CG, the first target information is for the first CG, and the second target information is for the second CG.

Alternatively, the second information is configured to indicate that the PUSCH corresponding to the CG is transmitted according to two unified TCI states, or the PUSCH corresponding to the CG is transmitted according to one or two unified TCI states. The CG corresponding to the second information may be one, or may be all CGs on the BWP, or may be all CGs on the serving cell. In this way, whether to use one or two unified TCI states for the uplink transmission is determined by explicit indication information, so that on the one hand, the implementation complexity of the terminal device can be effectively reduced, and on the other hand, the readability of the protocol can be increased. For example, deriving from multiple pieces of configuration information can be avoided.

In some embodiments, the second information is configured to indicate that the CG corresponds to multiple SRS resources, and the PUSCH corresponding to the CG is transmitted according to one or more TCI states. For example, the second information is configured to indicate that the CG corresponds to multiple SRS resources, and the PUSCH corresponding to the CG is transmitted according to multiple TCI states, or is transmitted according to one or more TCI states.

In another embodiment, the second information is configured to indicate that the CG corresponds to one SRS resource, and the PUSCH corresponding to the CG is transmitted according to one TCI state.

In some embodiments, the second information is configured to indicate that the CG corresponds to multiple SRS resources through srs-ResourceIndicator and srs-ResourceIndicator2 configured in an RRC parameter rrc-ConfiguredUplinkGrant.

In another embodiment, the second information is configured to indicate that the CG corresponds to one SRS resource by configuring srs-ResourceIndicator and not configuring srs-ResourceIndicator2 in the RRC parameter rrc-ConfiguredUplinkGrant, or by configuring srs-ResourceIndicator2 and not configuring srs-ResourceIndicator in the RRC parameter rrc-ConfiguredUplinkGrant.

In some embodiments, the second information is configured to indicate the multiple SRS resources corresponding to the CG by activating the DCI of the CG.

In other embodiments, the second information is configured to indicate the one SRS resource corresponding to the CG by activating the DCI of the CG.

In some embodiments, the second information is of the first value, which indicates that the PUSCH corresponding to the CG is transmitted according to one TCI state. For example, when the second information is of the first value, the PUSCH corresponding to the CG is transmitted according to one TCI state.

In some other embodiments, the second information is of the second value, which indicates that the PUSCH corresponding to the CG is transmitted according to one or more TCI states. Exemplarily, the second information is of the second value, which indicates that the PUSCH corresponding to the CG is transmitted according to one or more TCI states, or indicates that the PUSCH corresponding to the CG is transmitted according to multiple TCI states. For example, when the second information is of the second value, the PUSCH corresponding to the CG is transmitted according to multiple TCI states, or is transmitted according to one or more TCI states.

In some embodiments, when the second information is received by the terminal device, the PUSCH corresponding to the CG is transmitted according to one TCI state.

In some other embodiments, when the second information is not received by the terminal device, the PUSCH corresponding to the CG is transmitted according to one or more TCI states. For example, when the second information is not received by the terminal device, the PUSCH corresponding to the CG is transmitted according to multiple TCI states, or is transmitted according to one or more TCI states.

In some embodiments, when the network device transmits the second information, the PUSCH corresponding to the CG is transmitted according to one TCI state.

In some other embodiments, when the network device does not transmit the second information, the PUSCH corresponding to the CG is transmitted according to one or more TCI states.

In some embodiments, when the second information is received by the terminal device, the PUSCH corresponding to the CG is transmitted according to one or more TCI states. For example, when the second information is received by the terminal device, the PUSCH corresponding to the CG is transmitted according to multiple TCI states, or is transmitted according to one or more TCI states.

In some other embodiments, when the second information is not received by the terminal device, the PUSCH corresponding to the CG is transmitted according to one TCI state.

In some embodiments, when the network device transmits the second information, the PUSCH corresponding to the CG is transmitted according to one or more TCI states. For example, when the network device transmits the second information, the PUSCH corresponding to the CG is transmitted according to multiple TCI states, or is transmitted according to one or more TCI states.

In some other embodiments, when the network device does not transmit the second information, the PUSCH corresponding to the CG is transmitted according to one TCI state.

Alternatively, when the CG corresponds to two SRS resources or two SRS resource indicators, the corresponding PUSCH is transmitted according to two unified TCI states, or is transmitted according to one or two unified TCI states, so that the existing RRC indication information can be reused, and the signaling design workload and product implementation complexity can be reduced.

Alternatively, two SRS resource indicators are indicated by srs-ResourceIndicator and srs-ResourceIndicator2 in the RRC parameter rrc-ConfiguredUplinkGrant.

Alternatively, two SRS resources are indicated in the DCI activating the CG.

Alternatively, when the CG corresponds to one SRS resource or one SRS resource indicator, the corresponding PUSCH is transmitted according to one unified TCI state, so that existing RRC indication information can be reused, and the signaling design workload and product implementation complexity can be reduced.

Alternatively, one SRS resource indicator is indicated by configuring srs-ResourceIndicator and not configuring srs-ResourceIndicator2 in the RRC parameter rrc-ConfiguredUplinkGrant. Alternatively, one SRS resource indicator is indicated by configuring srs-ResourceIndicator2 and not configuring srs-ResourceIndicator in the RRC parameter rrc-ConfiguredUplinkGrant.

Alternatively, one SRS resource is indicated in the DCI activating the CG.

It should be noted that, in some embodiments of the present disclosure, the DCI activating the CG is denoted as the second DCI.

Alternatively, the second information is configured to indicate that the PUSCH corresponding to the CG is transmitted according to one unified TCI state. Alternatively, the second information is configured to indicate that the PUSCH corresponding to the CG is transmitted according to two unified TCI states, or is transmitted according to one or two unified TCI states. Alternatively, the second information is configured to indicate that the PUSCH corresponding to the CG is transmitted according to two unified TCI states.

In this way, whether to use one or two unified TCI states for the uplink transmission is determined by explicit indication information. On one hand, the implementation complexity of the terminal device can be effectively reduced, and on the other hand, the readability of the protocol can be increased. For example, deriving from multiple pieces of configuration information can be avoided.

Alternatively, when the second information is of the first value, the PUSCH corresponding to the CG is transmitted according to one unified TCI state. When the second information is of the second value, the PUSCH corresponding to the CG is transmitted according to two unified TCI states, or is transmitted according to one or two unified TCI states.

Alternatively, when the terminal device receives the second information or the network device configures the second information, the PUSCH corresponding to the CG is transmitted according to one unified TCI state. When the second information is not received by the terminal device or the network device does not configure the second information, the PUSCH corresponding to the CG is transmitted according to two unified TCI states, or is transmitted according to one or two unified TCI states, so that the signaling overhead can be reduced by configuring and not configuring the related indication information.

Alternatively, when the second information is received by the terminal device or the network device configures the second information, the PUSCH corresponding to the CG may be transmitted according to two unified TCI states, or may be transmitted according to one or two unified TCI states. When the second information is not received by the terminal device or the network device does not configure the second information, the PUSCH corresponding to the CG may be transmitted according to one unified TCI state, so that the signaling overhead can be reduced by configuring and not configuring the related indication information.

In some embodiments, the terminal device may receive SRS configuration information. The SRS configuration information indicates two SRS resource sets, and the usages of the two SRS resource sets are both set to “codebook” or both set to “nonCodebook”. In some other embodiments, the network device may transmit the SRS configuration information.

Alternatively, the usages of the RRC parameters in the two SRS resource set (denoted as the first SRS resource set and the second SRS resource set, respectively) configuration parameters SRS-ResourceSet are both set to “codebook” or both set to “nonCodebook”.

In some embodiments, the method further includes the following operations. The terminal device receives the third information. The third information is configured to indicate activated TCI states available for the uplink transmission. The operation that the terminal device transmits the PUSCH corresponding to the CG according to one or more TCI states includes the following operation. The terminal device transmits the PUSCH corresponding to the CG according to one or more TCI states of the activated TCI states available for the uplink transmission.

In some embodiments, the method further includes the following operation. The network device transmits the third information. The third information is configured to indicate activated TCI states available for the uplink transmission. One or more TCI states of the activated TCI states available for the uplink transmission are used for the terminal device to transmit the PUSCH corresponding to the CG.

Alternatively, the activated TCI states available for the uplink transmission may be K1 TCI states. Alternatively, the activated TCI states available for the uplink transmission may be unified TCI states. Alternatively, the K1 TCI states may be K1 unified TCI states.

In some embodiments, the method further includes the following operation. The network device transmits the third information. The third information is configured to indicate activated TCI states available for the uplink transmission. Alternatively, the “activated” TCI states indicated by the third information may be applied TCI states indicated by the third information. The activated or applied TCI states are used for subsequent transmission of part or all of the downlink (DL) and/or uplink (UL) channels/signals.

Alternatively, current activated TCI states available for the uplink transmission are K1 TCI states (for example, they may be joint TCI states or UL TCI states).

Alternatively, before the terminal device/network device determines that current activated TCI states available for the uplink transmission are K1 TCI states, the terminal device may receive the third information transmitted by the network device. The third information is configured to indicate N TCI states. Alternatively, the N TCI states may be N unified TCI states.

Alternatively, the terminal device determines the K1 activated (active or applied) TCI states according to the third information.

Alternatively, the third information is indicated by an MAC CE or an RRC signaling.

Alternatively, the third information is transmitted by a DCI signaling.

In any embodiment of the present disclosure, the DCI used for transmitting the third information may be denoted as the first DCI.

Alternatively, the third information is transmitted through the first field in the DCI signaling. The first field is a Transmission configuration indication field in the DCI signaling.

Alternatively, at least part of the N TCI states is used to determine/indicate the uplink transmission.

Alternatively, K1 TCI states of the N TCI states are used for uplink, and K2 TCI states of the N TCI states are used for downlink.

In one case, 0<=K1<=N, 0<=K2<=N. For example, N=K1=K2, N=K1, K2=0, or other combinations. For example, K1=N UL TCI states and N Joint TCI states may be used for both uplink and downlink, that is, N=K1=K2.

Alternatively, the terminal device further receives seventh information transmitted by the network device, and determines N TCI states indicated by the third information according to the seventh information.

Alternatively, the terminal device determines a spatial relationship or an uplink transmission spatial filter (UL TX spatial filter) of the PUSCH corresponding to the CG according to the third information.

In any embodiment of the present disclosure, the beam, the spatial domain filter, the spatial filter, the spatial domain parameter, the spatial parameter, the spatial domain setting, the spatial setting, the QCL information, the QCL hypothesis, the QCL indication, the TCI state (DL TCI state, UL TCI state, Joint TCI state), the spatial relation and the like may be replaced with each other, and the above-mentioned terms are also equivalent to each other.

Alternatively, the terminal device determines the spatial relation or the uplink transmission spatial filter of the PUSCH according to a reference signal in the TCI state that can be used for uplink (i.e., the UL TCI state) of the N TCI states.

Alternatively, the terminal device determines the spatial relation or the uplink transmission spatial filter of the PUSCH according to a reference signal corresponding to the type D in a TCI state that can be used for both uplink and downlink (i.e., a Joint TCI state) of the N TCI states.

In some embodiments, the operation that the terminal device transmits the PUSCH corresponding to the CG according to one or more TCI states includes the following operation. When a first number of activated TCI states available for the uplink transmission is less than or equal to a second number of TCI states for transmitting the PUSCH corresponding to the CG indicated by the second information, the terminal device transmits the PUSCH corresponding to the CG according to the first number of the activated TCI states available for the uplink transmission.

In some other embodiments, the operation that the terminal device transmits the PUSCH corresponding to the CG according to one or more TCI states includes the following operation. When the first number of the activated TCI states available for the uplink transmission is greater than the second number of the TCI states for transmitting the PUSCH corresponding to the CG indicated by the second information, the terminal device transmits the PUSCH corresponding to the CG according to a third number of the activated TCI states available for the uplink transmission. The third number is less than or equal to the second number.

In some embodiments, when the first number of activated TCI states available for the uplink transmission is less than or equal to the second number of TCI states for transmitting the PUSCH corresponding to the CG indicated by the second information, the PUSCH corresponding to the CG is transmitted according to the activated TCI states available for the uplink transmission.

In some other embodiments, when the first number of the activated TCI states available for the uplink transmission is greater than the second number of the TCI states for transmitting the PUSCH corresponding to the CG indicated by the second information, the PUSCH corresponding to the CG is transmitted according to the third number of the activated TCI states available for the uplink transmission. The third number is less than or equal to the second number.

Alternatively, the activated TCI states available for the uplink transmission may be indicated by the network device through the third information, and/or may be indicated by the terminal device according to the pre-configured information. Alternatively, the second number of indicated TCI states for transmitting the PUSCH corresponding to the CG may be indicated by the network device through the second information, and/or may be indicated by the terminal device according to the pre-configured information.

Alternatively, the first number may be an integer greater than or equal to 1, and the second number may be an integer greater than or equal to 1. For example, the first number may be 1, 2, 3, 4, or 8, etc., and the second number may be 1, 2, 3, 4, or 8, etc.

In some embodiments, the operation that the terminal device transmits the PUSCH corresponding to the CG according to one or more TCI states includes the following operation. When the activated TCI states available for the uplink transmission include the first TCI state, and a number of TCI states for transmitting the PUSCH corresponding to the CG indicated by the second information is one or more, the terminal device transmits the PUSCH corresponding to the CG according to the first TCI state.

In some embodiments, when the activated TCI states available for the uplink transmission include a first TCI state, and a number of TCI states for transmitting the PUSCH corresponding to the CG indicated by the second information is one or more, the PUSCH corresponding to the CG is transmitted according to the first TCI state.

For example, the operation that the terminal device transmits the PUSCH corresponding to the CG according to one or more TCI states includes the following operation. When the activated TCI states available for the uplink transmission includes the first TCI state, and the number of TCI states for transmitting the PUSCH corresponding to the CG indicated by the second information is multiple or one or more, the terminal device transmits the PUSCH corresponding to the CG according to the first TCI state.

Alternatively, the activated TCI state available for the uplink transmission may be indicated by the network device through the third information, and/or may be indicated by the terminal device according to the pre-configured information. Alternatively, the number of indicated TCI states for transmitting the PUSCH corresponding to the CG is a multiple or one or more, which may be indicated by the network device through the second information, and/or may be indicated by the terminal device according to the pre-configured information.

In some embodiments, the operation that the terminal device transmits the PUSCH corresponding to the CG according to the first TCI state includes the following operation. The terminal device transmits the PUSCH corresponding to the CG according to the first TCI state and the first SRS resource.

In some embodiments, the PUSCH corresponding to the CG is transmitted according to the first TCI state and the first SRS resource.

Alternatively, the first SRS resource corresponds to the first precoding and/or the first number of layers, and the PUSCH corresponding to the CG is transmitted based on the first precoding and/or the first number of layers. Alternatively, the first number of layers may be a first number of streams or a first rank in other embodiments.

In some embodiments, the first SRS resource is indicated by srs-ResourceIndicator in the RRC parameter rrc-ConfiguredUplinkGrant.

In some other embodiments, the first SRS resource is indicated by srs-ResourceIndicator2 in the RRC parameter rrc-ConfiguredUplinkGrant.

In yet other embodiments, the first SRS resource is jointly indicated by srs-ResourceIndicator and srs-ResourceIndicator2 in the RRC parameter rrc-ConfiguredUplinkGrant.

In some embodiments, the method further includes the following operation. The terminal device receives the fourth information. The fourth information is configured to indicate that the first SRS resource is indicated by srs-ResourceIndicator in the RRC parameter rrc-ConfiguredUplinkGrant.

In other embodiments, the method further includes the following operation. The terminal device receives the fourth information. The fourth information is configured to indicate that the first SRS resource is indicated by srs-ResourceIndicator2 in the RRC parameter rrc-ConfiguredUplinkGrant.

In yet other embodiments, the method further includes the following operation. The terminal device receives the fourth information. The fourth information is configured to indicate that the first SRS resource is jointly indicated by srs-ResourceIndicator and srs-ResourceIndicator2 in the RRC parameter rrc-ConfiguredUplinkGrant.

In some embodiments, the method further includes the following operation. The network device transmits the fourth information. The fourth information is configured to indicate that the first SRS resource is indicated by srs-ResourceIndicator in the RRC parameter rrc-ConfiguredUplinkGrant.

In some other embodiments, the method further includes the following operation. The network device transmits the fourth information. The fourth information is configured to indicate that the first SRS resource is indicated by srs-ResourceIndicator2 in the RRC parameter rrc-ConfiguredUplinkGrant.

In yet other embodiments, the method further includes the following operation. The network device transmits the fourth information. The fourth information is configured to indicate that the first SRS resource is jointly indicated by srs-ResourceIndicator and srs-ResourceIndicator2 in the RRC parameter rrc-ConfiguredUplinkGrant.

In some embodiments, the first SRS resource is determined by an SRS resource indication field in the DCI.

In some other embodiments, the first SRS resource is determined by the second SRS resource indication field in the DCI.

Alternatively, in any embodiment of the present disclosure, the DCI may be the first DCI or the second DCI unless otherwise specified.

In some embodiments, the method further includes the following operation. The terminal device receives the fifth information. The fifth information is configured to indicate that the first SRS resource is determined by an SRS resource indication field in the DCI.

In some other embodiments, the method further includes the following operation. The terminal device receives the fifth information. The fifth information is configured to indicate that the first SRS resource is determined by the second SRS resource indication field in the DCI.

In yet other embodiments, the method further includes the following operation. The terminal device receives the fifth information. The fifth information is configured to indicate that the first SRS resource is jointly determined by the SRS resource indication field and the second SRS resource indication field in the DCI.

In some embodiments, the method further includes the following operation. The network device transmits the fifth information. The fifth information is configured to indicate that the first SRS resource is determined by the SRS resource indication field in the DCI.

In some other embodiments, the method further includes the following operation. The network device transmits the fifth information. The fifth information is configured to indicate that the first SRS resource is determined by the second SRS resource indication field in the DCI.

In yet other embodiments, the method further includes the following operation. The network device transmits the fifth information. The fifth information is configured to indicate that the first SRS resource is jointly determined by the SRS resource indication field and the second SRS resource indication field in the DCI.

In some embodiments, the operation that the terminal device transmits the PUSCH corresponding to the CG according to the first TCI state includes the following operation. The terminal device transmits the PUSCH corresponding to the CG according to the first TCI state, the first SRS resource and the second SRS resource.

In some embodiments, the PUSCH corresponding to the CG is transmitted according to the first TCI state, the first SRS resource and the second SRS resource.

In some embodiments, an uplink transmission spatial filter or a spatial relation related to PUSCH transmission corresponding to the first SRS resource is determined according to the first TCI state. An uplink transmission spatial filter or a spatial relation related to PUSCH transmission corresponding to the second SRS resource is determined according to the first TCI state.

In some embodiments, the method further includes the following operation. The terminal device receives the sixth information. The sixth information is configured to indicate that the PUSCH corresponding to the CG is transmitted according to the first TCI state and the first SRS resource.

In other embodiments, the method further includes the following operation. The terminal device receives the sixth information. The sixth information is configured to indicate that the PUSCH corresponding to the CG is transmitted according to the first TCI state, the first SRS resource and the second SRS resource.

In some embodiments, the method further includes the following operation. The network device transmits the sixth information. The sixth information is configured to indicate that the PUSCH corresponding to the CG is transmitted according to the first TCI state and the first SRS resource.

In other embodiments, the method further includes the following operation. The network device transmits the sixth information. The sixth information is configured to indicate that the PUSCH corresponding to the CG is transmitted according to the first TCI state, the first SRS resource and the second SRS resource.

The following describes a manner in which the terminal device transmits the PUSCH corresponding to the CG in the case that the activated TCI states available for the uplink transmission includes the first TCI state, that the number of indicated TCI states for transmitting the PUSCH corresponding to the CG is multiple, or that the number of indicated TCI states for transmitting the PUSCH corresponding to the CG is one or more.

Alternatively, when the current activated TCI states available for the uplink transmission are K1 TCI states, K1=1, and the PUSCH corresponding to the CG is transmitted according to two unified TCI states, or is transmitted according to one or two unified TCI states, the following options may be provided.

Alternatively, the terminal device determines the PUSCH transmission according to the K1 TCI state (K1=1, that is, the first TCI state described above). That is, for the single transmission or repetition of the PUSCH, the uplink transmission spatial filter or spatial relation are determined by using the K1 TCI state (K1=1).

Alternatively, there is a scheme A1 in which the terminal device determines the PUSCH transmission according to the first SRS resource and the K1 TCI state (K1=1), so that when a single TCI is indicated by the network, by using only one piece of indication information of the SRS resource, the processing complexity of the terminal device can be reduced, and the energy consumption of the terminal device can be saved.

Alternatively, the first SRS resource is indicated by the RRC parameter srs-ResourceIndicator in the RRC parameter RRC-ConfiguredUplinkGrant, or the first SRS resource is indicated by the RRC parameter srs-ResourceIndicator2 in the RRC parameter RRC-ConfiguredUplinkGrant. Thus, the first SRS resource indication information is determined according to the prescribed RRC parameter, so that the complexity of product implementation can be effectively reduced.

Alternatively, the terminal device determines whether the first SRS resource is indicated by the RRC parameter srs-ResourceIndicator in the RRC parameter RRC-ConfiguredUplinkGrant or the RRC parameter srs-ResourceIndicator2 in the RRC parameter RRC-ConfiguredUplinkGrant according to the fourth information. In this way, the flexibility of the system can be improved, and greater freedom can be provided for the network to optimize the configuration and transmission.

Alternatively, the first SRS resource is determined by the “SRS resource indicator” indication field in the DCI, or the first SRS resource is determined by the “Second SRS resource indicator” indication field in the DCI. Alternatively, the DCI may be the first DCI or the second DCI. In this way, the first SRS resource indication information is determined according to the prescribed DCI field, so that the complexity of product implementation can be effectively reduced.

Alternatively, the terminal device determines whether the first SRS resource is determined by the “SRS resource indicator” indication field in the DCI or the “Second SRS resource indicator” indication field in the DCI according to the fifth information. Alternatively, the DCI may be the first DCI or the second DCI. In this way, the flexibility of the system can be improved, and greater freedom can be provided for the network to optimize the configuration and transmission.

Alternatively, there is a scheme A2 in which the terminal device determines the PUSCH transmission according to the first SRS resource, the second SRS resource and the K1 TCI (K1=1). In this way, even when the system indicates only one TCI state for downlink, the repetition of the PUSCH is still supported, so that the reliability of the PUSCH transmission can be improved.

Alternatively, the first SRS resource and the second SRS resource are indicated by the RRC parameters srs-ResourceIndicator and srs-ResourceIndicator2 in the RRC parameter RRC-ConfiguredUplinkGrant, respectively.

Alternatively, the first SRS resource and the second SRS resource are determined by “SRS resource indicator” in the DCI and “Second SRS resource indicator” in the DCI, respectively. Alternatively, the DCI may be the first DCI or the second DCI.

Alternatively, when the PUSCH corresponding to the first SRS resource is transmitted, the uplink transmission spatial filter or spatial relation is determined according to the K1 TCI state (K1=1). When the PUSCH corresponding to the second SRS resource is transmitted, the uplink transmission spatial filter or spatial relation is determined according to the K1 TCI state (K1=1).

Alternatively, the terminal device receives the sixth information transmitted by the network device to determine whether to adopt the scheme A1 or the scheme A2. In this way, the flexibility of the system can be improved, and greater freedom can be provided for the network to optimize the configuration and transmission.

Alternatively, the fourth information is transmitted through an RRC signaling, an MAC CE signaling, or a DCI signaling. Alternatively, the fifth information is transmitted through an RRC signaling, an MAC CE signaling, or a DCI signaling. Alternatively, the sixth information is transmitted through an RRC signaling, an MAC CE signaling, or a DCI signaling.

In some embodiments, the operation that the terminal device transmits the PUSCH corresponding to the CG according to one or more TCI states includes the following operation. When the activated TCI states available for the uplink transmission include the first TCI state and the second TCI state, and a number of TCI states for transmitting the PUSCH corresponding to the CG indicated by the second information is one or more, the terminal device transmits the PUSCH corresponding to the CG according to the first TCI state and the second TCI state.

In some embodiments, when the activated TCI states available for the uplink transmission include the first TCI state and the second TCI state, and the number of TCI states for transmitting the PUSCH corresponding to the CG indicated by the second information is one or more, the PUSCH corresponding to the CG is transmitted according to the first TCI state and the second TCI state.

For example, the operation that the terminal device transmits the PUSCH corresponding to the CG according to one or more TCI states includes the following operation. When the activated TCI states available for the uplink transmission includes the first TCI state and the second TCI state, and the number of TCI states for transmitting the PUSCH corresponding to the CG indicated by the second information is multiple, or one or more, the terminal device transmits the PUSCH corresponding to the CG according to the first TCI state and the second TCI state.

Alternatively, the activated TCI states available for the uplink transmission may be indicated by the network device through the third information, and/or may be indicated by the terminal device according to the pre-configured information. Alternatively, the number of indicated TCI states for transmitting the PUSCH corresponding to the CG is multiple or one or more, which may be indicated by the network device through the second information, and/or may be indicated by the terminal device according to the pre-configured information.

In some embodiments, the operation that the terminal device transmits the PUSCH corresponding to the CG according to the first TCI state and the second TCI state includes the following operation. The terminal device transmits the PUSCH corresponding to the CG according to the first TCI state, the second TCI state, the first SRS resource and the second SRS resource. The first SRS resource corresponds to the first TCI state, and the second SRS resource corresponds to the second TCI state.

In some embodiments, the PUSCH corresponding to the CG is transmitted according to the first TCI state, the second TCI state, the first SRS resource and the second SRS resource. The first SRS resource corresponds to the first TCI state, and the second SRS resource corresponds to the second TCI state.

Alternatively, the first SRS resource corresponds to the first precoding and/or the first number of layers, and the PUSCH corresponding to the CG associated with the first TCI state is transmitted based on the first precoding and/or the first number of layers. Alternatively, the first number of layers may be a first number of streams or a first rank in other embodiments.

Alternatively, the second SRS resource corresponds to the second precoding and/or the second number of layers, and the PUSCH corresponding to the CG associated with the second TCI state is transmitted based on the second precoding and/or the second number of layers. Alternatively, the second number of layers may be a second number of streams or a second rank in other embodiments.

In some embodiments, an uplink transmission spatial filter or a spatial relation related to PUSCH transmission corresponding to the first SRS resource is determined according to the first TCI state, and an uplink transmission spatial filter or a spatial relation related to PUSCH transmission corresponding to the second SRS resource is determined according to the second TCI state.

In some embodiments, the first SRS resource is indicated by srs-ResourceIndicator in the RRC parameter rrc-ConfiguredUplinkGrant. The second SRS resource is indicated by srs-ResourceIndicator2 in the RRC parameter rrc-ConfiguredUplinkGrant.

In some embodiments, an SRS resource with a lesser identification of SRS resources indicated by srs-ResourceIndicator and srs-ResourceIndicator2 in the RRC parameter rrc-ConfiguredUplinkGrant is the first SRS resource, and a SRS resource with a greater identification is the second SRS resource. Alternatively, an SRS resource with a greater identification is the first SRS resource, and an SRS resource with a lesser identification is the second SRS resource.

Alternatively, the identification of the SRS resource indicated by the srs-ResourceIndicator may be the srs-ResourceIndicator. Alternatively, the identification of the SRS resource indicated by srs-ResourceIndicator2 may be srs-ResourceIndicator2.

In some embodiments, the first SRS resource is determined by an SRS resource indication field in the DCI. The second SRS resource is determined by the second SRS resource indication field in the DCI.

In some embodiments, an SRS resource with a lesser identification of SRS resources indicated by the SRS resource indication field in the DCI and by the second SRS resource indication field in the DCI is the first SRS resource, and an SRS resource with a greater identification is the second SRS resource. Alternatively, an SRS resource with a greater identification is the first SRS resource, and an SRS resource with a lesser identification is the second SRS resource.

In some embodiments, the first TCI state is a TCI state with a minimum identification of multiple activated TCI states available for the uplink transmission, and the second TCI state is a TCI state with a maximum identification or a second minimum identification of the multiple activated TCI states available for the uplink transmission.

In other embodiments, the first TCI state is a TCI state with the maximum [00272] identification of the multiple activated TCI states available for the uplink transmission, and the second TCI state is a TCI state with the minimum identification or a second maximum identification of the multiple activated TCI states available for the uplink transmission.

In some embodiments, the method further includes the following operation. The terminal device receives the seventh information. The first TCI state is a TCI state, of multiple activated TCI states available for the uplink transmission, at a foremost position of multiple TCI states indicated by the seventh information, and the second TCI state is a TCI state, of the multiple activated TCI states available for the uplink transmission, at a furthest position or a second foremost position of the multiple TCI states indicated by the seventh information.

In some other embodiments, the method further includes the following operation. The terminal device receives the seventh information. The first TCI state is a TCI state, of the multiple activated TCI states available for the uplink transmission, at the furthest position of the multiple TCI states indicated by the seventh information, and the second TCI state is a TCI state, of the multiple activated TCI states available for the uplink transmission, at the foremost position or a second furthest position of the multiple TCI states indicated by the seventh information.

In some embodiments, the method further includes the following operation. The network device transmits the seventh information. The first TCI state is a TCI state, of multiple activated TCI states available for the uplink transmission, at a foremost position of multiple TCI states indicated by the seventh information, and the second TCI state is a TCI state, of the multiple activated TCI states available for the uplink transmission, at a furthest position or a second foremost position of the multiple TCI states indicated by the seventh information.

In other embodiments, the method further includes the following operation. The network device transmits the seventh information. The first TCI state is a TCI state, of the multiple activated TCI states available for the uplink transmission, at the furthest position of the multiple TCI states indicated by the seventh information, and the second TCI state is a TCI state, of the multiple activated TCI states available for the uplink transmission, at the foremost position or a second furthest position of the multiple TCI states indicated by the seventh information.

In some embodiments, the method further includes the following operation. The terminal device receives the eighth information. The eighth information is configured to indicate that the first TCI state is a TCI state with the minimum identification of multiple activated TCI states available for the uplink transmission, and the second TCI state is a TCI state with the maximum identification or a second minimum identification of the multiple activated TCI states available for the uplink transmission.

In some other embodiments, the method further includes the following operation. The terminal device receives the eighth information. The eighth information is configured to indicate that the first TCI state is a TCI state with the maximum identification of the multiple activated TCI states available for the uplink transmission, and the second TCI state is a TCI state with the minimum identification or a second maximum identification of the multiple activated TCI states available for the uplink transmission.

In some embodiments, the method further includes the following operation. The network device transmits the eighth information. The eighth information is configured to indicate that the first TCI state is a TCI state with the minimum identification of multiple activated TCI states available for the uplink transmission, and the second TCI state is a TCI state with the maximum identification or a second minimum identification of the multiple activated TCI states available for the uplink transmission.

In other embodiments, the method further includes the following operation. The network device transmits the eighth information. The eighth information is configured to indicate that the first TCI state is a TCI state with the maximum identification of the multiple activated TCI states available for the uplink transmission, and the second TCI state is a TCI state with the minimum identification or a second maximum identification of the multiple activated TCI states available for the uplink transmission.

In some embodiments, the method further includes the following operation. The terminal device receives the ninth information. The ninth information is configured to indicate that the first TCI state is a TCI state, of the multiple activated TCI states available for the uplink transmission, at a foremost position of multiple TCI states indicated by the seventh information received by the terminal device, and the first TCI state is a TCI state, of the multiple activated TCI states available for the uplink transmission, at a furthest position or a second foremost position of the multiple TCI states indicated by the seventh information.

In other embodiments, the method further includes the following operation. The terminal device receives the ninth information. The ninth information is configured to indicate that the first TCI state is a TCI state, of the multiple activated TCI states available for the uplink transmission, at the furthest position of the multiple TCI states indicated by the seventh information received by the terminal device, and the first TCI state is a TCI state, of the multiple activated TCI states available for the uplink transmission, at the foremost position or a second furthest position of the multiple TCI states indicated by the seventh information.

In some embodiments, the method further includes the following operation. The network device transmits the ninth information. The ninth information is configured to indicate that the first TCI state is a TCI state, of the multiple activated TCI states available for the uplink transmission, at a foremost position of multiple TCI states indicated by the seventh information received by the terminal device, and the first TCI state is a TCI state, of the multiple activated TCI states available for the uplink transmission, at a furthest position or a second foremost position of the multiple TCI states indicated by the seventh information.

In some other embodiments, the method further includes the following operation. The network device transmits the ninth information. The ninth information is configured to indicate that the first TCI state is a TCI state, of the multiple activated TCI states available for the uplink transmission, at the furthest position of the multiple TCI states indicated by the seventh information received by the terminal device, and the first TCI state is a TCI state, of the multiple activated TCI states available for the uplink transmission, at the foremost position or a second furthest position of the multiple TCI states indicated by the seventh information.

The following describes a manner in which the terminal device transmits the PUSCH corresponding to the CG when the activated TCI states available for the uplink transmission includes the first TCI state and the second TCI state, the number of indicated TCI states for transmitting the PUSCH corresponding to the CG is multiple, or the number of indicated TCI states for transmitting the PUSCH corresponding to the CG is one or more.

Alternatively, in a case that the current activated TCI states available for the uplink transmission are K1 TCI states, when K1>1 (taking K1=2 as an example), and the PUSCH corresponding to the CG is transmitted according to 2 unified TCI states or is transmitted according to 1 or 2 unified TCI states, the following options may be provided.

Alternatively, the terminal device determines the PUSCH transmission according to the first SRS resource, the second SRS resource and the first TCI state of the K1 TCI states (K1=2). The first SRS resource corresponds to the first TCI state, and the second SRS resource corresponds to the second TCI state.

Alternatively, when the PUSCH corresponding to the first SRS resource is transmitted, the uplink transmission spatial filter or spatial relation is determined according to the first TCI state, and when the PUSCH corresponding to the second SRS resource is transmitted, the uplink transmission spatial filter or spatial relation is determined according to the second TCI state.

Alternatively, the first SRS resource and the second SRS resource are indicated by the RRC parameters srs-ResourceIndicator and srs-ResourceIndicator2 in the RRC parameter RRC-ConfiguredUplinkGrant, respectively. In this way, the first SRS resource and the second SRS resource are determined according to the RRC parameter, and the complexity of product implementation can be effectively reduced.

Alternatively, an SRS resource with a lesser ID of two SRS resources indicated by the RRC parameters srs-ResourceIndicator and srs-ResourceIndicator2 in the RRC parameter rrc-ConfiguredUplinkGrant is the first SRS resource, and an SRS resource with a greater ID is the second SRS resource. Alternatively, the SRS resource with a greater ID is the first SRS resource, and the SRS resource with a lesser ID is the second SRS resource. In this way, the flexibility of the system can be improved.

Alternatively, the first SRS resource and the second SRS resource are determined by “SRS resource indicator” in the DCI and “Second SRS resource indicator” in the DCI, respectively. Alternatively, the DCI may be the first DCI or the second DCI. In this way, the first SRS resource and the second SRS resource are determined according to the DCI indication field, and the complexity of product implementation can be effectively reduced.

Alternatively, an SRS resource with a lesser ID of two SRS resources indicated by the “SRS resource indicator” in the DCI and the “Second SRS resource indicator” in the DCI is the first SRS resource is the first SRS resource, and an SRS resource with a greater ID is the second SRS resource. Alternatively, the SRS resource with a greater ID is the first SRS resource, and the SRS resource with a lesser ID is the second SRS resource. In this way, the flexibility of the system can be increased.

Alternatively, there is a scheme B1 in which the first TCI state is the TCI state with the minimum ID of the K1 TCI states, and the second TCI state is the TCI state with the maximum ID or the second minimum ID of the K1 TCI states. In this way, the corresponding TCI state is determined according to the preset rules, which can effectively reduce the complexity of product implementation.

Alternatively, there is a scheme B2 in which the first TCI state is the TCI state with the maximum ID of the K1 TCI states, and the second TCI state is the TCI state with the minimum ID or the second maximum ID of the K1 TCI states. In this way, the corresponding TCI state is determined according to the preset rules, which can effectively reduce the complexity of product implementation.

Alternatively, there is a scheme B3 in which the first TCI state is a TCI state, of the K1 TCI states, at a foremost position in the seventh information, and the second TCI state is a TCI state, of the K1 TCI states, at a furthest position or a second foremost position in the seventh information. In this way, the corresponding TCI state is determined according to the preset rules, which can effectively reduce the complexity of product implementation.

Alternatively, there is a scheme B4 in which the first TCI state is a TCI state, of the K1 TCI states, at a furthest position in the seventh information, and the second TCI state is a TCI state, of the K1 TCI states, at a foremost position or a second furthest position in the seventh information. In this way, the corresponding TCI state is determined according to the preset rules, which can effectively reduce the complexity of product implementation.

Alternatively, the terminal device determines, according to the eighth information transmitted by the network device, whether the first TCI state and the second TCI state are determined according to the scheme B1 or the scheme B2. In this way, the configuration is performed through the indication information, so that the system flexibility can be increased and the degree of freedom can be provided for the optimization of the network.

Alternatively, the terminal device determines, according to the ninth information transmitted by the network device, whether the first TCI state and the second TCI state are determined according to the scheme B3 or the scheme B4. In this way, the configuration is performed through the indication information, so that the system flexibility can be increased and the degree of freedom can be provided for the optimization of the network.

Alternatively, the eighth information is transmitted by an RRC signaling, an MAC CE signaling, or a DCI signaling. Alternatively, the ninth information is transmitted by an RRC signaling, an MAC CE signaling, or a DCI signaling.

In some embodiments, the operation that the terminal device transmits the PUSCH corresponding to the CG according to one or more TCI states includes the following operation. When the activated TCI states available for the uplink transmission include the first TCI state and the second TCI state, and a number of TCI states for transmitting the PUSCH corresponding to the CG indicated by the second information is one, the terminal device transmits the PUSCH corresponding to the CG according to the first TCI state or the second TCI state.

In some embodiments, when the activated TCI states available for the uplink transmission include the first TCI state and the second TCI state, and the number of TCI states for transmitting the PUSCH corresponding to the CG indicated by the second information is one, the PUSCH corresponding to the CG is transmitted according to the first TCI state or the second TCI state.

Alternatively, the activated TCI states available for the uplink transmission may be indicated by the network device through the third information, and/or may be indicated by the terminal device according to the pre-configured information. Alternatively, the number of indicated TCI states for transmitting the PUSCH corresponding to the CG may be one, which may be indicated by the network device through the second information, and/or may be indicated by the terminal device according to the pre-configured information.

In some embodiments, the operation that the terminal device transmits the PUSCH corresponding to the CG according to the first TCI state or the second TCI state includes the following operation. The terminal device transmits the PUSCH corresponding to the CG according to a TCI state with a lesser identification of the first TCI state and the second TCI state.

In some other embodiments, the operation that the terminal device transmits the PUSCH corresponding to the CG according to the first TCI state or the second TCI state includes the following operation. The terminal device transmits the PUSCH corresponding to the CG according to a TCI state with a greater identification of the first TCI state and the second TCI state.

In still other embodiments, the operation that the terminal device transmits the PUSCH corresponding to the CG according to the first TCI state or the second TCI state includes the following operation. The terminal device transmits the PUSCH corresponding to the CG according to a more forward TCI state between the first TCI state and the second TCI state among multiple TCI states indicated by the seventh information received by the terminal device.

In still other embodiments, the operation that the terminal device transmits the PUSCH corresponding to the CG according to the first TCI state or the second TCI state includes the following operation. The terminal device transmits the PUSCH corresponding to the CG according to a farther TCI state between the first TCI state and the second TCI state among the multiple TCI states indicated by the seventh information received by the terminal device.

On the network device side, the corresponding operations are as follows.

In some embodiments, the PUSCH corresponding to the CG is transmitted according to a TCI state with a lesser identification of the first TCI state and the second TCI state. In some other embodiments, the PUSCH corresponding to the CG is transmitted according to a TCI state with a greater identification of the first TCI state and the second TCI state. In still other embodiments, the PUSCH corresponding to the CG is transmitted according to a more forward TCI state between the first TCI state and the second TCI state among multiple TCI states indicated by the seventh information received by the terminal device. In still some embodiments, the PUSCH corresponding to the CG is transmitted according to a farther TCI state between the first TCI state and the second TCI state among the multiple TCI states indicated by the seventh information received by the terminal device.

In some embodiments, the method further includes the following operations. The [00309] terminal device receives the tenth information. The tenth information is configured to indicate that the PUSCH corresponding to the CG is transmitted according to a TCI state with a lesser identification of the first TCI state and the second TCI state.

In some other embodiments, the method further includes the following operation. The terminal device receives the tenth information. The tenth information is configured to indicate that the PUSCH corresponding to the CG is transmitted according to a TCI state with a greater identification of the first TCI state and the second TCI state.

In some embodiments, the method further includes the following operation. The network device transmits the tenth information. The tenth information is configured to indicate that the PUSCH corresponding to the CG is transmitted according to a TCI state with a lesser identification of the first TCI state and the second TCI state.

In still other embodiments, the method further includes the following operation. The network device transmits the tenth information. The tenth information is configured to indicate that the PUSCH corresponding to the CG is transmitted according to a TCI state with a greater identification of the first TCI state and the second TCI state.

In some embodiments, the method further includes the following operation. The terminal device receives eleventh information. The eleventh information is configured to indicate that the PUSCH corresponding to the CG is transmitted according to a more forward TCI state between the first TCI state and the second TCI state among multiple TCI states indicated by the seventh information received by the terminal device.

In other embodiments, the method further includes the following operation. The terminal device receives the eleventh information. The eleventh information is configured to indicate that the PUSCH corresponding to the CG is transmitted according to a farther TCI state between the first TCI state and the second TCI state among the multiple TCI states indicated by the seventh information received by the terminal device.

In some embodiments, the method further includes the following operation. The network device transmits the eleventh information. The eleventh information is configured to indicate that the PUSCH corresponding to the CG is transmitted according to a more forward TCI state between the first TCI state and the second TCI state among multiple TCI states indicated by the seventh information received by the terminal device.

In other embodiments, the method further includes the following operation. The network device transmits the eleventh information. The eleventh information is configured to indicate that the PUSCH corresponding to the CG is transmitted according to a farther TCI state between the first TCI state and the second TCI state among the multiple TCI states indicated by the seventh information received by the terminal device.

In some embodiments, the method further includes the following operation. At least one of the fourth information, the fifth information, the sixth information, the eighth information, the ninth information, the tenth information or the eleventh information is transmitted by an RRC signaling, an MAC CE signaling or a DCI signaling.

Alternatively, among the fourth information, the fifth information, the sixth information, the eighth information, the ninth information, the tenth information and the eleventh information, different information may be transmitted through different signaling or the same signaling.

The following describes a manner in which the terminal device transmits the PUSCH corresponding to the CG when the activated TCI states available for the uplink transmission include the first TCI state and the second TCI state, and the number of indicated TCI state for transmitting the PUSCH corresponding to the CG is one.

Alternatively, in a case that the current activated TCI states available for the uplink transmission are K1 TCI states, when K1=2 and the PUSCH corresponding to the CG is transmitted according to one unified TCI state, the following options may be provided.

Alternatively, the terminal device determines the corresponding PUSCH transmission according to the first TCI state. Alternatively, the uplink transmission spatial filter or spatial relation is determined according to the first TCI state for the corresponding PUSCH transmission.

Alternatively, there is a scheme C1 in which the first TCI state is the TCI state with the minimum ID of the K1 TCI states. In this way, the corresponding TCI state is determined according to the preset rules, and the complexity of product implementation can be effectively reduced.

Alternatively, there is a scheme C2 in which the first TCI state is the TCI state with the maximum ID of the K1 TCI states. In this way, the corresponding TCI state is determined according to the preset rules, and the complexity of product implementation can be effectively reduced.

Alternatively, there is a scheme C3 in which the first TCI state is a TCI state, of the K1 TCI states, at a foremost position in the seventh information. In this way, the corresponding TCI state is determined according to the preset rules, and the complexity of product implementation can be effectively reduced.

Alternatively, there is a scheme C4 in which the first TCI state is a TCI state, of the K1 TCI states, at a furthest position in the seventh information. In this way, the corresponding TCI state is determined according to the preset rules, and the complexity of product implementation can be effectively reduced.

Alternatively, the terminal device determines, according to the tenth information transmitted by the network device, whether the first TCI state is determined according to the scheme C1 or the scheme C2. In this way, the configuration is performed through the indication information, so that the system flexibility can be increased and the degree of freedom can be provided for the optimization of the network.

Alternatively, the terminal device determines, according to the eleventh information transmitted by the network device, whether the first TCI state is determined according to the scheme C3 or the scheme C4. In this way, the configuration is performed through the indication information, so that the system flexibility can be increased and the degree of freedom can be provided for the optimization of the network.

Alternatively, the tenth information is transmitted through an RRC signaling, an MAC CE signaling, or a DCI signaling. Alternatively, the eleventh information is transmitted by an RRC signaling, an MAC CE signaling, or a DCI signaling.

In some embodiments, the seventh information is transmitted by an MAC CE signaling.

In some embodiments, the MAC CE signaling (corresponding to the following first MAC CE signaling) for transmitting the seventh information includes at least one of: DL BWP indication information, UL BWP indication information, one or more TCI number indication fields, one or more TCI state type indication fields, or one or more pieces of TCI state indication information. Each TCI number indication field indicates that one codepoint corresponds to one or more TCI states, and each TCI state type indication field indicates that a corresponding TCI state is a DL TCI state, a joint TCI state, or an UL TCI state.

Alternatively, the seventh information is transmitted by the first MAC CE signaling.

Alternatively, the first MAC CE signaling includes the DL BWP indication information.

Alternatively, the first MAC CE signaling includes the UL BWP indication information.

Alternatively, the first MAC CE signaling includes one or more TCI number indication fields. Each indication field indicates that one codepoint corresponds to one or more TCI states.

Alternatively, the first MAC CE signaling includes one or more TCI state type indication fields. Each TCI state type indication field is configured to indicate whether the corresponding TCI state is a DL/Joint TCI state or an UL TCI state.

Alternatively, the first MAC CE signaling includes one or more pieces of TCI state indication information.

In some embodiments, the method further includes the following operation. The terminal device receives the twelfth information. The twelfth information is configured to indicate that a TCI state type includes a joint TCI state or a separate TCI state.

In some embodiments, the method further includes the following operation. The terminal device transmits twelfth information. The twelfth information is configured to indicate that a TCI state type includes a joint TCI state or a separate TCI state.

Alternatively, the terminal device may further receive twelfth information transmitted by the network device. The twelfth information is configured to indicate that the unified TCI state type is a joint TCI state. Thus, the K1 TCI states are K1 joint TCI states.

Alternatively, the terminal device may further receive twelfth information transmitted by the network device. The twelfth information is configured to indicate that the unified TCI state type is a separate TCI state. Thus, the K1 TCI states are K1 UL TCI states.

In some embodiments, the terminal device transmits at least one of: first capability information, second capability information, or third capability information. In some embodiments, the network device receives at least one of: first capability information, second capability information, or third capability information.

The first capability information is configured to indicate that the terminal device supports a fourth number of TCI states for uplink transmission or uplink repetition, or the first capability information is configured to indicate that the terminal device supports that a codepoint in a TCI field in DCI activates or indicates at most the fourth number of TCI states for the uplink transmission or the uplink repetition.

The second capability information is configured to indicate that the terminal device supports transmitting the PUSCH corresponding to the CG.

The third capability information is configured to indicate that the terminal device supports transmitting the PUSCH corresponding to the CG according to the fourth number of TCI states.

Alternatively, at least one of the first capability information, the second capability information, or the third capability information may be capability information of the terminal device.

In some embodiments, the fourth number is 2 or 4.

In some embodiments, when the terminal device transmits the first capability information and the second capability information, the first capability information and the second capability information are transmitted through the same signaling, or the first capability information and the second capability information are transmitted through different signaling.

In some embodiments, for the network device side, the network device receives the first capability information and the second capability information through the same signaling, or the network device receives the first capability information and the second capability information through different signaling.

In some embodiments, at least one of the first capability information, the second capability information or the third capability information is transmitted through an RRC signaling or an MAC CE signaling.

For example, the first capability information is transmitted through an RRC signaling or an MAC CE signaling. For another example, the second capability information is transmitted through an RRC signaling or an MAC CE signaling. For yet another example, the third capability information is transmitted through an RRC signaling or an MAC CE signaling.

In some embodiments, at least one of the first capability information, the second capability information or the third capability information is reported for a band, and/or is reported independently according to a band combination, and/or is reported independently according to each band in a band combination, and/or is reported independently according to each carrier on each band in a band combination, and/or is reported according to a Frequency Range (FR), and/or is reported for the terminal device.

For example, the first capability information is reported for a band, or is reported independently according to a band combination, or is reported independently according to each band in a band combination, or is reported independently according to each carrier on each band in a band combination, or is reported independently according to a FR, or is reported for the terminal device.

For example, the second capability information is reported for a band, or is reported independently according to a band combination, or is reported independently according to each band in a band combination, or is reported independently according to each carrier on each band in a band combination, or is reported independently according to a FR, or is reported for the terminal device.

For example, the third capability information is reported for a band, or is reported independently according to a band combination, or is reported independently according to each band in a band combination, or is reported independently for each carrier on each band in a band combination, or is reported independently according to a Frequency Range (FR), or is reported for the terminal device.

Alternatively, the reporting methods of different capability information may be the same or different.

In some embodiments, the TCI state is a unified TCI state.

Alternatively, the terminal device reports the first capability information to the network device. The first capability information is configured to indicate that the terminal device supports Z1 (Z>1) unified TCIs for uplink transmission or uplink repetition, or the first capability information is configured to indicate that the terminal device supports that one codepoint in the TCI field in the DCI may activate or indicate at most Z1 unified TCIs for the uplink transmission.

Alternatively, Z1 is 2, or Z1 is 4.

Alternatively, the first capability information is transmitted by an RRC signaling or an MAC CE.

Alternatively, the first capability information is reported for a band (that is, corresponding capabilities may be reported independently for different bands, per band). In this way, independent reporting for different bands may provide greater freedom for implementation of the terminal device. For example, the terminal device can support this function on one or some bands, but do not support this function on other bands, thereby allowing more terminal devices to support this new function.

Alternatively, the first capability information is independently reported according to a band combination (per band combination). In this way, independent reporting for different band combinations may provide greater freedom for implementation of the terminal device. For example, the terminal device may not support this function on a certain band combination, but support this function on another band combination, thereby allowing more terminal devices to support this new function.

Alternatively, the first capability information is independently reported according to each band in a band combination (that is, reports are independent for bands in different band combinations, per band per band combination). In this way, independent reporting for different band combinations may provide greater freedom for implementation of the terminal device. For example, the terminal device may not support this function under a certain Carrier Aggregation (CA), but support this function on some bands of another CA combination, thereby allowing more terminal devices to support this new function.

Alternatively, the first capability information is independently reported for each carrier on each band in a band combination (that is, reports are independent for different carriers (Component Carriers, CC) on a band in different band combinations, per CC per band per band combination or Feature Set Per Component-carrier (FSPC)). In this way, reports can be independent for different band combinations, and reports can be independent for different carriers on a band, so that greater freedom can be provided for implementation of the terminal device, thereby allowing more terminal devices to support this new function.

Alternatively, the first capability information is reported according to a FR (that is, reports are independent for different FRs, per FR, in other words, reports are independent for FR1 and FR2). In this way, independent reporting for different FRs may provide greater freedom for implementation of the terminal device. For example, the terminal device does not support this function at the low frequency (FR1), but supports this function at the high frequency (FR2), thereby allowing more terminal devices to support this new function.

Alternatively, the first capability information is reported for a terminal device (UE) (that is, per UE, in other words, if a terminal device reports this capability, the terminal device may support this capability in each band). In this way, the signaling overhead of the capability reporting of the terminal device can be reduced.

Alternatively, the terminal device reports the second capability information to the network device, and the second capability information is configured to indicate that the terminal device supports the CG-PUSCH.

Alternatively, the second capability information is transmitted by an RRC signaling or an MAC CE.

Alternatively, the description of the first capability information may be similarly used for the second capability information, and the first capability information and the second capability information may correspond to different or the same options. For example, one piece of capability information is for band and the other piece of capability information is for per CC per band per band combination. Since for the uplink and downlink, capability requirements for the terminal device are different, different options may be used for the capabilities in the uplink and downlink, which may be more beneficial for the implementation of the terminal device.

Alternatively, the first capability information and the second capability information are the same terminal device capability (i.e., the third capability information described above). That is, the capability supports determining the uplink transmission spatial filter or spatial related information in the CG-PUSCH according to Z1 TCI states (Z1>1).

Alternatively, the first capability information and the second capability information are reported by the same signaling or different signaling.

Hereinafter, an embodiment of the communication method in the embodiments of the present disclosure would be further described.

The terminal device receives the first information transmitted by the network device, and the first information is configured to indicate one or more CGs (CG Configuration). Alternatively, the first information may indicate one or more CGs on one BWP.

Alternatively, the type of CG is a CG Type 1 or a CG Type 2.

Alternatively, when the type of CG is CG Type 1, the first information further includes rrc-ConfiguredUplinkGrant in the RRC parameter configuredGrantConfig for the CG.

Alternatively, when the type of CG is CG Type 2, the first information does not include rrc-ConfiguredUplinkGrant in the RRC parameter configuredGrantConfig for the CG.

Alternatively, the first information may indicate one or more pieces of the following information of the CG: frequency domain frequency hopping indication information (e.g., intra-slot hopping and/or inter-slot hopping), DMRS indication information, resource allocation indication information (e.g., time domain and/or frequency domain resource allocation), power control parameter indication information, precoding indication information, SRS resource indication information, repetition indication information, or Hybrid Automatic Repeat reQuest (HARQ) process (HARQ process) indication information.

Alternatively, when DCI format 0_0 or DCI format 0_1 activates a CG (when the type of the CG is the CG Type 2) to transmit the PUSCH or when transmitting the PUSCH corresponding to the CG (when the type of the CG is the CG Type 1), the information of the CG may be used, and at the same time, some or all of the following information of pusch-Config in the RRC parameter may be used: dataScramblingIdentityPUSCH, Transmission Config (txConfig), codebookSubset, maximum number of transmission streams (maxRank), or scaling of UCI-OnPUSCH.

Alternatively, when the DCI format 0_2 activates the CG (when the type of the CG is the CG Type 2) to transmit the PUSCH corresponding to the CG, the information of the CG is used, and some or all of the following information of pusch-Config in the RRC parameter may also be used: dataScramblingIdentityPUSCH, txConfig, codebook SubsetDCI-0-2, maxRankDCI-0-2, scaling of UCI-OnPUSCH, or resource Allocation Type 1 GranularityDCI-0-2.

Alternatively, when the type of CG is the CG Type 2, the DCI (denoted as the second DCI) for activating the CG satisfies one or more of the following conditions.

A Cyclic Redundancy Check (CRC) used by the DCI is scrambled by using the following parameters: a Configured Scheduling-Radio Network Temporary Identity (CS-RNTI), or a Group-Configured Scheduling-Radio Network Temporary Identity (G-CS-RNTI).

The new data indication field in the DCI is set to 0. The new data indication field in the DCI may be a Downlink Feedback Information (DFI) flag field (DFI flag field).

If the DFI flag field exists in the DCI, this field is set to 0.

The time domain resource allocation indication field in the DCI indicates a row corresponding to one Start and lengthindicator value (SLIV).

Alternatively, when there is one CG, the provisions of some fields in the DCI for activating the CG are shown in Table 1.

TABLE 1

| | DCI format | DCI format | DCI format |
|---|---|---|---|
| | 0_0/0_1/0_2 | 1_0/1_2/4_1 | 1_1/4_2 |
| HARQ process | set to all ‘0's | set to all ‘0's | set to all ‘0's |
| number | | | |
| Redundancy | set to all ‘0's | set to all ‘0's | For the enabled |
| version | | | transport block: set to |
| | | | all ‘0's |

When there are multiple CGs, the provisions of some fields in the DCI for activating the CGs are shown in Table 2.

TABLE 2

| | DCI format | DCI format | DCI format |
|---|---|---|---|
| | 0_0/0_1/0_2 | 1_0/1_2/4_1 | 1_1/4_2 |
| Redundancy | set to all ‘0's | set to all ‘0's | For the enabled |
| version | | | transport block: set to |
| | | | all ‘0's |

Alternatively, the terminal device may further receive the twelfth information transmitted by the network device.

Two embodiments are provided below.

In the first embodiment, the twelfth information is configured to indicate that the type of the unified TCI state is a joint TCI state.

Alternatively, the joint TCI state may be used for UL operation or UL transmission, or may be used for DL operation or DL transmission/reception.

Alternatively, the twelfth information is indicated by an RRC Information Element (IE) parameter unifiedTCI-StateType, and the value thereof is “Joint”.

Alternatively, the twelfth information is configured for the serving cell.

Alternatively, the twelfth information is indicated in the RRC IE parameter ServingCellConfig.

Alternatively, the terminal device further receives thirteenth information transmitted by the network device, and is used for configuring or indicating a set of TCI states (denoted as the first TCI state set). The first TCI state set includes one or more TCI states.

Alternatively, the first TCI state set may be used for the UL operation or the UL transmission, and/or may be used for the DL operation or the DL transmission.

Alternatively, the thirteenth information is configured by an RRC parameter.

Alternatively, the thirteenth information is configured in the RRC IE parameter PDSCH-Config.

Alternatively, the thirteenth information is indicated by the RRC IE parameter ul-OrJoint-TCIStateList.

In the second embodiment, the twelfth information is configured to indicate that the type of the unified TCI state is a separate TCI state.

Alternatively, the UL TCI state is used for UL operation or UL transmission, and

the DL TCI state is used for DL operation or DL transmission.

Alternatively, the twelfth information is indicated by an RRC IE parameter unifiedTCI-StateType, and the value thereof is “Separate”.

Alternatively, the twelfth information is configured for the serving cell.

Alternatively, the twelfth information is indicated in the RRC IE parameter ServingCellConfig.

Alternatively, the terminal device further receives fourteenth information transmitted by the network device, and the fourteenth information is used for configuring or indicating the second TCI state set. The second TCI state set includes one or more DL TCI states.

Alternatively, the second TCI state set is used for DL operation or DL transmission.

Alternatively, the fourteenth information is configured by an RRC parameter.

Alternatively, the fourteenth information is configured in the RRC IE parameter PDSCH-Config.

Alternatively, the fourteenth information is indicated by the RRC IE parameter dl-OrJoint-TCIStateList-r17.

Alternatively, the terminal device further receives fifteenth information transmitted by the network device, and the fifteenth information is used for configuring or indicating the third TCI state set. The third TCI state set includes one or more UL TCI states.

Alternatively, the third UL TCI state set is used for UL operation or UL transmission.

Alternatively, the fifteenth information is configured by an RRC parameter.

Alternatively, the fifteenth information is configured in the RRC IE parameter BWP-UplinkDedicated.

Alternatively, the fifteenth information is indicated by an RRC IE parameter ul-TCI-ToAddModList.

The seventh information is described below.

Alternatively, the terminal device receives the seventh information transmitted by the network device, and the seventh information is transmitted by the first MAC CE signaling. In this way, using the MAC CE signaling has lower the delay than using the RRC signaling, and has better transmission reliability, thereby facilitating the network to quickly instruct the terminal device to perform corresponding operations.

Alternatively, the first MAC CE signaling includes at least one or more pieces of the following information.

(1) Serving cell indication information. For example, the Serving cell indication information may be a serving cell ID to indicate a corresponding serving cell, and the MAC CE is applied to the serving cell. Alternatively, the length of this information field is 5 bits.

(2) DL BWP indication information. For example, the DL BWP indication information may be a DL BWP ID to indicate a corresponding DL BWP, and the MAC CE is applied to the DL BWP. Alternatively, the length of this information field is 2 bits.

(3) UL BWP indication information. For example, UL BWP indication information may be an UL BWP ID to indicate a corresponding UL BWP, and the MAC CE is applied to the UL BWP. Alternatively, the length of this information field is 2 bits.

(4) Multiple TCI state indication fields. Each indication field indicates one TCI state, and the one TCI state belongs to one of the first TCI state set.

(5) One or more indication fields. Each indication field indicates whether a corresponding TCI state exists. Alternatively, the indication field is in the same Octet (Oct) as another TCI state indication field.

(6) K TCI number indication fields. Each indication field indicates that one codepoint corresponds to N TCI states. In this way, the total number of UL TCI states and DL TCI states are indicated, the number of bits is reduced, and the overhead of MAC CE signaling is compressed. Alternatively, each indication field has 2 bits or 3 bits.

Alternatively, in the second embodiment described above, the value of N may be a value of 1, 2, 3, or 4. In this way, the protocol design and system implementation are simple, and most of the performance gains of M-TRP and good flexibility in network configuration and scheduling can be obtained.

Alternatively, the number of DL TCI states is less than or equal to 2. Alternatively, the number of UL TCI states is less than or equal to 2.

Alternatively, in the first embodiment described above, each indication field indicates that one codepoint corresponds to one or two Joint TCI states.

Alternatively, in the second embodiment described above, the value of N may be a value of 1, 2, 3, 4, 5, or 6. In this way, more TRPs are supported for the downlink transmission, which improves the downlink performance in some scenarios and provides greater freedom for the optimization of the network.

Alternatively, the number of DL TCI states is less than or equal to 4. Alternatively, the number of UL TCI states is less than or equal to 2.

Alternatively, in the second embodiment described above, the value of N may be a value of 1, 2, 3, 4, 5, 6, 7, or 8. In this way, more TRPs are supported for the downlink transmission and the uplink transmission. In some scenarios, the downlink performance and the uplink performance are improved, and greater freedom for the optimization of the network is provided.

Alternatively, the number of DL TCI states is less than or equal to 4. Alternatively, the number of UL TCI states is less than or equal to 4.

Alternatively, for the first embodiment described above, each indication field indicates that one codepoint corresponds to one, two, three or four Joint TCI states. In this way, more TRPs are supported for the downlink transmission and uplink transmission. In some scenarios, the downlink performance and the uplink performance are improved, and greater freedom for the optimization of the network is provided.

Alternatively, K is 8 or 16.

(7) TCI state type indication field. The TCI state type indication field is used for indicating whether the corresponding TCI state is a DL/Joint TCI state or a UL TCI state.

Alternatively, the TCI state type indication field is used to indicate whether the TCI state indication information in the same octet indicates a DL/Joint TCI state or a UL TCI state.

Alternatively, the TCI state type indication field is used to indicate whether the TCI state indication information in the same octet indicates the TCI state in the second TCI state set or the TCI state in the third TCI state set.

(8) TCI state indication information.

Alternatively, if the TCI state indication information is used to indicate a DL/Joint TCI state, the length of the indication information is 7 bits.

Alternatively, if the TCI state indication information is used to indicate the UL TCI state, the length of the indication information is 7 bits. In this way, more UL TCI states can be indicated, and the flexibility of the network scheduling can be improved.

Alternatively, if the TCI state indication information is used to indicate the UL TCI state, the most significant bit in the indication information is a reserved bit, and the remaining 6 bits indicate the UL TCI state.

(9) TCI state subset number (or DCI codepoint) number indication information. The information indicates a positive integer between 1 and K (denoted as A). In this way, the terminal device can reduce the reading/parsing of some bits of information, and the implementation complexity of the terminal device can be reduced.

Alternatively, the value refers to the number of codepoints of the first field in the DCI corresponding to the TCI state indicated in the second MAC CE. Alternatively, the first field is a TCI field in the DCI.

Alternatively, the maximum number of TCI states indicated by the first MAC CE is 32. In this way, transmission of up to 2 TRPs is supported for both uplink and downlink, (2+2)*8=32. Alternatively, the maximum number of TCI states indicated by the first MAC CE is 48. In this way, transmission of up to 4 TRPs for downlink and transmission of up to 2 TRPs for uplink are supported, which improves downlink transmission performance, improves the flexibility of network configuration and scheduling, and controls the implementation complexity of terminal device within a certain range. Alternatively, the maximum number of TCI states indicated by the first MAC CE is 64. In this way, transmission of up to 4 TRPs for downlink and transmission of up to 4 TRPs for uplink are supported, which improves downlink transmission performance and uplink transmission performance, and improves the flexibility of network configuration and scheduling at the expense of implementation complexity of the terminal device.

Alternatively, the maximum number of TCI states activated by the first MAC CE may be 32, 48 or 64.

Alternatively, the maximum number of Joint TCI states activated by the first MAC CE is 16 or 32.

On the previous basis, current activated TCI states available for uplink transmission are K1 TCI states (which may be, for example, joint TCI states or UL TCI states). Prior to this, the terminal device may receive the third information transmitted by the network device, and the third information is configured to indicate N TCI states. Alternatively, the terminal device determines the K1 activated (active or applied) TCI states according to the third information.

Alternatively, the terminal device receives the third information transmitted by the network device, and the terminal device determines one or more pieces of the following information according to the third information.

(1) QCL information corresponding to PDSCH DMRS.

(2) QCL information corresponding to PDCCH DMRS, or, QCL information corresponding to DMRS that corresponds to part of CORESETs.

(3) QCL information corresponding to at least part of the CSI-RSs.

(4) UL TX spatial filter of PUSCH.

(5) An uplink transmission spatial filter of at least part of the PUCCHs.

(6) An uplink transmission spatial filter of at least part of the SRSs.

(7) An RRC parameter followUnifiedTCIstateSRS-r17 configured in an SRS

resource set corresponding to at least part of the SRSs.

Alternatively, the third information is transmitted by the DCI signaling (denoted as a first DCI). Alternatively, the third information is transmitted by a TCI field in the DCI signaling.

Alternatively, the third information may be the same information as the seventh information. For example, if the seventh information only indicates the TCI state corresponding to the first codepoint and does not indicate the TCI states corresponding to other codepoints other than the first codepoint, and the first codepoint corresponds to the TCI state X1 and/or the TCI state X2, the terminal device may directly determine the activated TCI state according to the TCI state X1 and/or the TCI state X2. Alternatively, the third information may be different from the seventh information, for example, if the seventh information (for example, an MAC CE) is configured to indicate that the first codepoint corresponds to the TCI state X1 and/or the TCI state X2, the second codepoint corresponds to the TCI state X3, and the third information is configured to indicate the first codepoint through the corresponding information field in the DCI, the terminal device may determine the activated TCI state according to the TCI state X1 and/or the TCI state X2.

Alternatively, the DCI is DCI format 1_1 and/or DCI format 1_2. The DCI format 1_1/1_2 may simultaneously schedule data or may not schedule downlink transmission (i.e., with or without, if applicable, DL assignment).

Alternatively, the DCI is DCI format 1_1 and/or DCI format 1_2 and/or DCI format 0_1 and/or DCI format 0_2. The DCI format 1_1/1_2 may simultaneously schedule data or may not schedule downlink transmission (i.e., with or without, if applicable, DL assignment), and the DCI format 0_1/0_2 may simultaneously schedule data or may not schedule uplink transmission (i.e., with or without, if applicable, UL assignment).

Alternatively, if without DL assignment, the terminal device may make the following assumptions for the DCI format 1_1/1_2 (in other words, the DCI format 1_1/1_2 satisfies the following conditions):

(1) CS-RNTI is used to scramble the CRC of DCI; and (2) the values of the following DCI fields are set as follows:
Redundancy Version (RV)=all “1”;
MCS=all “1”;
new data indicator (NDI)=0;
Frequency Domain Resource Allocation (FDRA) type 0 is set to all “0”, or FDRA type 1 is set to all “1”, or dynamicSwitch is set to all “0”.

Alternatively, if at least one TCI state (denoted as TCI state X) of the one or more TCI states indicated by the third information is different from any one of the previously indicated TCI states (the same direction is considered. For example, if the TCI state X is used for the uplink transmission, it is considered that the previously indicated TCI states for the uplink transmission are different from the TCI state X. If the TCI state X is used for the downlink transmission/reception, it is considered that that the previously indicated TCI states for the downlink transmission/reception are different from the TCI state X. If the TCI state X is used for the uplink transmission and the downlink transmission/reception, it is considered that the previously indicated TCI states for the uplink transmission and the downlink transmission/reception are different from the TCI state X), or if at least one TCI state (denoted as TCI state X) of the one or more TCI states indicated by the third information is different from any one of any one of the TCI states currently activated/applied by the terminal device, starting from the first slot after at least an interval of BeamAppTime symbols from the last symbol of the first PUCCH, the TCI state X indicated by the third information is effective. That is, the terminal device may determine the uplink transmission spatial filter and/or the QCL information corresponding to the downlink transmission/reception according to the TCI state X. The first PUCCH transmission carries the HARQ-ACK information corresponding to the first information DCI.

Alternatively, when the terminal device transmits the last symbol of the PUCCH with HARQ-ACK information, the HARQ-ACK information corresponds to the DCI carrying the TCI state indication and does not have DL allocation, or the HARQ-ACK information corresponds to the PDSCH scheduled by the DCI carrying the TCI state indication. If the indicated TCI state is different from the previously indicated TCI states, the indicated DLorJointTCIState or UL-TCIstate should be applied from the first slot, which is at least the BeamAppTime symbol after the last symbol of the PUCCH. Both the first slot and the BeamAppTime symbol are determined on a carrier with the minimum Sub-Carrier Space (SCS) among the carriers to which the beam indication is applied.

Alternatively, taking one DCI indicating at most two TCI states for the downlink transmission/reception (DL operation, or DL transmission/reception) as an example, other cases (TCI states for uplink, or TCI states for both uplink and downlink) may be similarly extended. It is assumed that the network has previously indicated that TCI state A1 and TCI state A2 are used for the downlink transmission, that the signal indicated by the current DCI contains the TCI state X, and that the TCI state X and the TCI state A1/A2 are different, the above procedure may be considered to determine when the TCI state X can be applied. For another example, the terminal device currently uses one or two TCI states (denoted as A1, A2) to determine the QCL information corresponding to the downlink transmission. The signal indicated by the current DCI includes the TCI state X, and the TCI state X and the TCI state A1/A2 are different, so the above procedure may be considered to determine when the TCI state X can be applied.

Alternatively, the third information is configured to indicate N TCI states.

Alternatively, the terminal device determines the N TCI states according to the third information and the seventh information.

Alternatively, at least part of the N TCI states is used to determine/indicate the uplink transmission. Alternatively, K1 TCI states are used for uplink, K2 TCI states are used for downlink, 0<=K1<=N, 0<=K2<=N. For example, N=K1=K2, or N=K1 and K2=0, or other combinations. For example, there may be N UL TCI states (K1=N), and N Joint TCI states may be used for both uplink and downlink, that is, N=K1=K2.

Alternatively, the terminal device determines a spatial relation or an UL TX spatial filter of the PUSCH corresponding to the CG according to the third information.

Alternatively, the terminal device determines the spatial relation or the UL TX spatial filter of the PUSCH according to the reference signal in the TCI state used for uplink (i.e., the UL TCI state) among the N TCI states.

Alternatively, the terminal device determines the spatial relation or the UL TX spatial filter of the PUSCH according to the reference signal corresponding to type D in a TCI state that can be used for both uplink and downlink (i.e., a Joint TCI state) among the N TCI states.

Alternatively, the terminal device performs corresponding CG PUSCH transmission according to the first SRS resource and/or the second SRS resource as well as the respective corresponding first TCI state and/or the second TCI state.

Alternatively, the corresponding PUSCH is repeatedly transmitted K times (for example, the PUSCH may be transmitted in K consecutive slots. For another example, the PUSCH may have K times of nominal repetitions).

Alternatively, when K=2, the first SRS resource corresponds to the first time of transmission (e.g., the first slot among K consecutive slots, or the first time of repetition among K times of nominal repetitions), and the second SRS resource corresponds to the second time of transmission (e.g., the second slot among K consecutive slots, or the second time of repetition among K times of nominal repetitions). The subsequent several times of transmission all contain the two meanings. For example, the first SRS resource corresponds to the third time of transmission, and the second SRS resource corresponds to the fourth time of transmission, which would not be repeated herein. Alternatively, the first SRS resource corresponds to an odd number time of transmission and the second SRS resource corresponds to an even number time of transmission. In some other embodiments, the second SRS resource corresponds to an odd number time of transmission and the first SRS resource corresponds to an even number time of transmission.

Alternatively, when K>2, if cyclicMapping is indicated in the RRC IE ConfiguredGrantConfig (i.e. cyclicMapping is enabled), the first SRS resource and the second SRS resource are applied to the first time of transmission and the second time of transmission, respectively. The same mapping pattern is repeated sequentially until there are K times of transmission in total. Alternatively, the information unit, the information element and the information factor can be understood in the same manner.

Alternatively, when K>2, if sequentialMapping is indicated in the RRC IE ConfiguredGrantConfig (i.e. sequentialMapping is enabled), the first SRS resource is applied to the first time of transmission and the second time of transmission, the second SRS resource is applied to the third time of transmission and the fourth time of transmission, and the same mapping pattern is repeated sequentially until there are K times of transmission in total.

In the embodiments of the present disclosure, a scheme of the configuration, indication, and determination of the unified TCI state is given for a CG PUSCH transmission scheme in a multi-TRP/panel/beam transmission scenario.

Alternatively, the CG PUSCH separate configuration information is used to indicate whether it is single TRP (S-TRP) or multi-TRP (M-TRP) (which may be different from that scheduled by DCI). Alternatively, the signaling corresponds to different configuration graininess.

Alternatively, for CG PUSCH Type 1/Type 2, if the CG is M-TRP, the DCI only indicates how to transmit one TCI-state, and different specific schemes are given. Alternatively, if the CG is M-TRP, the DCI indicates how to transmit two TCI states, and different specific schemes are given. Alternatively, if the CG is S-TRP, the DCI indicates how to transmit two TCI states, and different specific schemes are given.

The preferred embodiments of the present disclosure have been described in detail above with reference to the accompanying drawings, but the present disclosure is not limited to the specific details in the above-described embodiments. Within the scope of the technical concept of the present disclosure, a variety of simple modifications can be made to the technical solutions of the present disclosure, and these simple modifications all belong to the scope of protection of the present disclosure. For example, various specific technical features described in the above specific embodiments can be combined in any suitable manner without contradiction, and various possible combinations would not be described separately in the present disclosure in order to avoid unnecessary repetition. For another example, various different embodiments of the present disclosure may be combined arbitrarily as long as they do not contradict the idea of the present disclosure, and they should be regarded as the disclosure of the present disclosure as well. For another example, on the premise that there is no conflict, various embodiments described in the present disclosure and/or the technical features in various embodiment can be arbitrarily combined with the prior art, and the technical solutions obtained after the combination should also fall within the scope of protection of the present disclosure.

It should also be understood that in various method embodiments of the present disclosure, the sizes of the serial numbers of the above-described processes do not mean the sequence of execution, and the sequence of execution of various processes should be determined by its function and internal logic and should not constitute any limitation on the implementation of the embodiments of the present disclosure. In addition, in the embodiments of the present disclosure, the terms “downlink”, “uplink” and “sidelink” are used to indicate the transmission direction of signals or data. The term “downlink” is used to indicate that the transmission direction of signals or data is a first direction transmitted from the station to the UE of the cell, and the term “uplink” is used to indicate that the transmission direction of signals or data is a second direction transmitted from the UE of the cell to the station. The term “sidelink” is used to indicate that the transmission direction of the signal or data is a third direction transmitted from the UE 1 to the UE 2. For another example, the term “downlink signal” indicates that the transmission direction of the signal is the first direction. In addition, in the embodiments of the present disclosure, the term “and/or” is only used for describing an association relationship between association objects, which means that there may be three kinds of relationship. Specifically, A and/or B, which may mean that A exists alone, A and B simultaneously exist, and B exists alone. In addition, the character “/” in the present disclosure generally indicates that there is an “or” relationship between the associated objects.

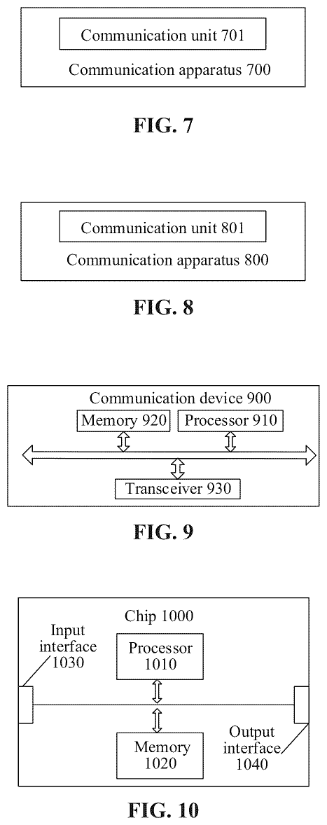

FIG. 7 is a diagram of a structural composition of a communication apparatus provided by the embodiment of the present disclosure. The communication apparatus is applied to a terminal device. As illustrated in n FIG. 7, the communication apparatus 700 includes a communication unit 701.

The communication unit 701 is configured to transmit a PUSCH corresponding to a CG according to one or more TCI states.

In some embodiments, the communication apparatus 700 further includes a determining unit. The determining unit is configured to determine the one or more TCI states.

In some embodiments, the communication unit 701 is further configured to receive first information indicating the CG.

In some embodiments, the communication unit 701 is further configured to receive second information indicating that the PUSCH corresponding to the CG is transmitted according to one or more TCI states.

In some embodiments, the CG corresponds to a BWP.

Alternatively, the CG corresponds to all CGs on a serving cell, a serving cell group or a band.

In some embodiments, the second information is configured to indicate that the CG corresponds to multiple SRS resources, and the PUSCH corresponding to the CG is transmitted according to one or more TCI states.

Alternatively, the second information is configured to indicate that the CG corresponds to one SRS resource, and the PUSCH corresponding to the CG is transmitted according to one TCI state.

In some embodiments, the second information is configured to indicate that the CG corresponds to multiple SRS resources through srs-ResourceIndicator and srs-ResourceIndicator2 configured in an RRC parameter rrc-ConfiguredUplinkGrant.

Alternatively, the second information is configured to indicate that the CG corresponds to one SRS resource by configuring srs-ResourceIndicator and not configuring srs-ResourceIndicator2 in the RRC parameter rrc-ConfiguredUplinkGrant, or by configuring srs-ResourceIndicator2 and not configuring srs-ResourceIndicator in the RRC parameter rrc-ConfiguredUplinkGrant.

In some embodiments, the second information is configured to indicate the multiple SRS resources corresponding to the CG by activating DCI of the CG. Alternatively, the second information is configured to indicate the one SRS resource corresponding to the CG by activating the DCI of the CG.

In some embodiments, the second information being of a first value indicates that the PUSCH corresponding to the CG is transmitted according to one TCI state. Alternatively, the second information being of a second value indicates that the PUSCH corresponding to the CG is transmitted according to one or more TCI states.

In some embodiments, when the second information is received by the terminal device, the PUSCH corresponding to the CG is transmitted according to one TCI state. Alternatively, when the second information is not received by the terminal device, the PUSCH corresponding to the CG is transmitted according to one or more TCI states.

In some embodiments, when the second information is received by the terminal device, the PUSCH corresponding to the CG is transmitted according to one or more TCI states. Alternatively, when the second information is not received by the terminal device, the PUSCH corresponding to the CG is transmitted according to one TCI state.

In some embodiments, the communication unit 701 is further configured to receive the third information indicating activated TCI states available for uplink transmission. The communication unit 701 is further configured to transmit the PUSCH corresponding to the CG according to one or more TCI states of the activated TCI states available for the uplink transmission.

In some embodiments, the communication unit 701 is further configured to, when a first number of activated TCI states available for uplink transmission is less than or equal to a second number of TCI states for transmitting the PUSCH corresponding to the CG indicated by the second information, transmit the PUSCH corresponding to the CG according to the first number of the activated TCI states available for the uplink transmission. Alternatively, the communication unit 701 is further configured to, when the first number of the activated TCI states available for the uplink transmission is greater than the second number of the TCI states for transmitting the PUSCH corresponding to the CG indicated by the second information, transmit the PUSCH corresponding to the CG according to a third number of the activated TCI states available for the uplink transmission. The third number is less than or equal to the second number.

In some embodiments, the communication unit 701 is further configured to, when activated TCI states available for uplink transmission include a first TCI state, and a number of TCI states for transmitting the PUSCH corresponding to the CG indicated by the second information is one or more, transmit the PUSCH corresponding to the CG according to the first TCI state.

In some embodiments, the communication unit 701 is further configured to transmit the PUSCH corresponding to the CG according to the first TCI state and the first SRS resource.

In some embodiments, the first SRS resource is indicated by srs-ResourceIndicator in an RRC parameter rrc-ConfiguredUplinkGrant. Alternatively, the first SRS resource is indicated by srs-ResourceIndicator2 in the RRC parameter rrc-ConfiguredUplinkGrant.

In some embodiments, the communication unit 701 is further configured to receive fourth information.

The fourth information is configured to indicate that the first SRS resource is indicated by srs-ResourceIndicator in an RRC parameter rrc-ConfiguredUplinkGrant. Alternatively, the fourth information is configured to indicate that the first SRS resource is indicated by srs-ResourceIndicator2 in the RRC parameter rrc-ConfiguredUplinkGrant.

In some embodiments, the first SRS resource is determined by an SRS resource indication field in DCI.

Alternatively, the first SRS resource is determined by a second SRS resource indication field in the DCI.

In some embodiments, the communication unit 701 is further configured to receive fifth information.

The fifth information is configured to indicate that the first SRS resource is determined by an SRS resource indication field in DCI. Alternatively, the fifth information is configured to indicate that the first SRS resource is determined by a second SRS resource indication field in the DCI.

In some embodiments, the communication unit 701 is further configured to transmit the PUSCH corresponding to the CG according to the first TCI state, a first SRS resource and a second SRS resource.

In some embodiments, an uplink transmission spatial filter or a spatial relation related to PUSCH transmission corresponding to the first SRS resource is determined according to the first TCI state, and an uplink transmission spatial filter or a spatial relation related to PUSCH transmission corresponding to the second SRS resource is determined according to the first TCI state.

In some embodiments, the communication unit 701 is further configured to receive sixth information. The sixth information is configured to indicate that the PUSCH corresponding to the CG is transmitted according to the first TCI state and a first SRS resource. Alternatively, the sixth information is configured to indicate that the PUSCH corresponding to the CG is transmitted according to the first TCI state, the first SRS resource and a second SRS resource.

In some embodiments, the communication unit 701 is further configured to, when activated TCI states available for uplink transmission include a first TCI state and a second TCI state, and a number of TCI states for transmitting the PUSCH corresponding to the CG indicated by the second information is one or more, transmit the PUSCH corresponding to the CG according to the first TCI state and the second TCI state.

In some embodiments, the communication unit 701 is further configured to transmit the PUSCH corresponding to the CG according to the first TCI state, the second TCI state, a first SRS resource and a second SRS resource. The first SRS resource corresponds to the first TCI state, and the second SRS resource corresponds to the second TCI state.

In some embodiments, an uplink transmission spatial filter or a spatial relation related to PUSCH transmission corresponding to the first SRS resource is determined according to the first TCI state, and an uplink transmission spatial filter or a spatial relation related to PUSCH transmission corresponding to the second SRS resource is determined according to the second TCI state.

In some embodiments, the first SRS resource is indicated by srs-ResourceIndicator in an RRC parameter rrc-ConfiguredUplinkGrant, and the second SRS resource is indicated by srs-ResourceIndicator2 in the RRC parameter rrc-ConfiguredUplinkGrant.

In some embodiments, an SRS resource with a lesser identification of SRS resources indicated by SRS-ResourceIndicator and SRS-ResourceIndicator2 in an RRC parameter rrc-ConfiguredUplinkGrant is the first SRS resource, a SRS resource with a greater identification is the second SRS resource. Alternatively, an SRS resource with a greater identification is the first SRS resource, and an SRS resource with a lesser identification is the second SRS resource.

In some embodiments, the first SRS resource is determined by an SRS resource indication field in DCI, and the second SRS resource is determined by a second SRS resource indication field in the DCI.

In some embodiments, an SRS resource with a lesser identification of SRS resources indicated by an SRS resource indication field in DCI and by a second SRS resource indication field in the DCI is the first SRS resource, and an SRS resource with a greater identification is the second SRS resource. Alternatively, an SRS resource with a greater identification is the first SRS resource, and an SRS resource with a lesser identification is the second SRS resource.

In some embodiments, the first TCI state is a TCI state with a minimum identification of multiple activated TCI states available for the uplink transmission, and the second TCI state is a TCI state with a maximum identification or a second minimum identification of the multiple activated TCI states available for the uplink transmission.

Alternatively, the first TCI state is a TCI state with the maximum identification of the multiple activated TCI states available for the uplink transmission, and the second TCI state is a TCI state with the minimum identification or a second maximum identification of the multiple activated TCI states available for the uplink transmission.

In some embodiments, the communication unit 701 is further configured to receive seventh information.

The first TCI state is a TCI state, of multiple activated TCI states available for the uplink transmission, at a foremost position of multiple TCI states indicated by the seventh information, and the second TCI state is a TCI state, of the multiple activated TCI states available for the uplink transmission, at a furthest position or a second foremost position of the multiple TCI states indicated by the seventh information. Alternatively, the first TCI state is a TCI state, of the multiple activated TCI states available for the uplink transmission, at the furthest position of the multiple TCI states indicated by the seventh information, and the second TCI state is a TCI state, of the multiple activated TCI states available for the uplink transmission, at the foremost position or a second furthest position of the multiple TCI states indicated by the seventh information.

In some embodiments, the communication unit 701 is further configured to receive eighth information.

The eighth information is configured to indicate that the first TCI state is a TCI state with a minimum identification of multiple activated TCI states available for the uplink transmission, and the second TCI state is a TCI state with a maximum identification or a second minimum identification of the multiple activated TCI states available for the uplink transmission. Alternatively, the eighth information is configured to indicate that the first TCI state is a TCI state with the maximum identification of the multiple activated TCI states available for the uplink transmission, and the second TCI state is a TCI state with the minimum identification or a second maximum identification of the multiple activated TCI states available for the uplink transmission.

In some embodiments, the communication unit 701 is further configured to receive ninth information.

The ninth information is configured to indicate that the first TCI state is a TCI state, of the multiple activated TCI states available for the uplink transmission, at a foremost position of multiple TCI states indicated by the seventh information received by the terminal device, and the first TCI state is a TCI state, of the multiple activated TCI states available for the uplink transmission, at a furthest position or a second foremost position of the multiple TCI states indicated by the seventh information. Alternatively, the ninth information is configured to indicate that the first TCI state is a TCI state, of the multiple activated TCI states available for the uplink transmission, at the furthest position of the multiple TCI states indicated by the seventh information received by the terminal device, and the first TCI state is a TCI state, of the multiple activated TCI states available for the uplink transmission, at the foremost position or a second furthest position of the multiple TCI states indicated by the seventh information.

In some embodiments, the communication unit 701 is further configured to, when activated TCI states available for uplink transmission include a first TCI state and a second TCI state, and a number of TCI states for transmitting the PUSCH corresponding to the CG indicated by the second information is one, transmit the PUSCH corresponding to the CG according to the first TCI state or the second TCI state.

In some embodiments, the communication unit 701 is further configured to transmit the PUSCH corresponding to the CG according to a TCI state with a lesser identification of the first TCI state and the second TCI state; or transmit the PUSCH corresponding to the CG according to a TCI state with a greater identification of the first TCI state and the second TCI state; or transmit the PUSCH corresponding to the CG according to a more forward TCI state between the first TCI state and the second TCI state among multiple TCI states indicated by the seventh information received by the terminal device; or transmit the PUSCH corresponding to the CG according to a farther TCI state between the first TCI state and the second TCI state among the multiple TCI states indicated by the seventh information received by the terminal device.

In some embodiments, the communication unit 701 is further configured to receive tenth information. The tenth information is configured to indicate that the PUSCH corresponding to the CG is transmitted according to a TCI state with a lesser identification of the first TCI state and the second TCI state. Alternatively, the tenth information is configured to indicate that the PUSCH corresponding to the CG is transmitted according to a TCI state with a greater identification of the first TCI state and the second TCI state.

In some embodiments, the communication unit 701 is further configured to receive eleventh information. The eleventh information is configured to indicate that the PUSCH corresponding to the CG is transmitted according to a more forward TCI state between the first TCI state and the second TCI state among multiple TCI states indicated by the seventh information received by the terminal device. Alternatively, the eleventh information is configured to indicate that the PUSCH corresponding to the CG is transmitted according to a farther TCI state between the first TCI state and the second TCI state among the multiple TCI states indicated by the seventh information received by the terminal device.

In some embodiments, at least one of the fourth information, the fifth information, the sixth information, the eighth information, the ninth information, the tenth information or the eleventh information is transmitted by an RRC signaling, an MAC CE signaling or a DCI signaling.

In some embodiments, the seventh information is transmitted by an MAC CE signaling.

In some embodiments, an MAC CE signaling for transmitting the seventh information includes at least one of the following:
DL BWP indication information;
UL BWP indication information;
one or more TCI number indication fields. Each TCI number indication field indicates that one codepoint corresponds to one or more TCI states;
one or more TCI state type indication fields. Each TCI state type indication field indicates that a corresponding TCI state is a DL TCI state, a joint TCI state, or an UL TCI state; or
one or more pieces of TCI state indication information.

In some embodiments, the communication unit 701 is further configured to receive twelfth information. The twelfth information is configured to indicate that a TCI state type includes a joint TCI state or a separate TCI state.

In some embodiments, the communication unit 701 is further configured to transmit at least one of first capability information, second capability information or third capability information. The first capability information is configured to indicate that the terminal device supports a fourth number of TCI states for uplink transmission or uplink repetition, or the first capability information is configured to indicate that the terminal device supports that a codepoint in a TCI field in DCI activates or indicates at most the fourth number of TCI states for the uplink transmission or the uplink repetition. The second capability information is configured to indicate that the terminal device supports transmitting the PUSCH corresponding to the CG. The third capability information is configured to indicate that the terminal device supports transmitting the PUSCH corresponding to the CG according to the fourth number of TCI states.

In some embodiments, the fourth number is 2 or 4.

In some embodiments, when the terminal device transmits the first capability information and the second capability information, the first capability information and the second capability information are transmitted through a same signaling, or the first capability information and the second capability information are transmitted through different signaling.

In some embodiments, at least one of the first capability information, the second capability information or the third capability information is transmitted by an RRC signaling or an MAC CE signaling.

In some embodiments, at least one of the first capability information, the second capability information or the third capability information is reported for a band, and/or is reported independently according to a band combination, and/or is reported independently according to each band in a band combination, and/or is reported independently according to each carrier on each band in a band combination, and/or is reported according to a Frequency Range (FR), and/or is reported for the terminal device.

In some embodiments, the TCI states are unified TCI states.

FIG. 8 is a diagram of a structural composition of another communication apparatus provided by an embodiment of the present disclosure. The communication apparatus is applied to a network device. As illustrated in FIG. 8, the communication apparatus 800 includes a communication unit 801. The communication unit 801 is configured to receive a PUSCH corresponding to a CG. The PUSCH corresponding to the CG is transmitted according to one or more TCI states.

In some embodiments, the communication apparatus 800 further includes a determining unit. The determining unit is configured to determine one or more TCI states.

In some embodiments, the communication unit 801 is further configured to transmit first information indicating the CG.

In some embodiments, the communication unit 801 is further configured to transmit second information indicating that the PUSCH corresponding to the CG is transmitted according to one or more TCI states.

In some embodiments, the CG corresponds to a BWP. Alternatively, the CG corresponds to all CGs on a serving cell, a serving cell group or a band.

In some embodiments, the second information is configured to indicate that the CG corresponds to multiple SRS resources, and the PUSCH corresponding to the CG is transmitted according to one or more TCI states. Alternatively, the second information is configured to indicate that the CG corresponds to one SRS resource, and the PUSCH corresponding to the CG is transmitted according to one TCI state.

In some embodiments, the second information is configured to indicate that the CG corresponds to multiple SRS resources through srs-ResourceIndicator and srs-ResourceIndicator2 configured in an RRC parameter rrc-ConfiguredUplinkGrant. Alternatively, the second information is configured to indicate that the CG corresponds to one SRS resource by configuring srs-ResourceIndicator and not configuring srs-ResourceIndicator2 in the RRC parameter rrc-ConfiguredUplinkGrant, or by configuring srs-ResourceIndicator2 and not configuring srs-ResourceIndicator in the RRC parameter rrc-ConfiguredUplinkGrant.

In some embodiments, the second information is configured to indicate the multiple SRS resources corresponding to the CG by activating DCI of the CG. Alternatively, the second information is configured to indicate the one SRS resource corresponding to the CG by activating the DCI of the CG.

In some embodiments, the second information is of a first value indicating that the PUSCH corresponding to the CG is transmitted according to one TCI state. Alternatively, the second information is of a second value indicating that the PUSCH corresponding to the CG is transmitted according to one or more TCI states.

In some embodiments, when second information is transmitted by the network device, the PUSCH corresponding to the CG is transmitted according to one TCI state. Alternatively, when the second information is not transmitted by the terminal device, the PUSCH corresponding to the CG is transmitted according to one or more TCI states.

In some embodiments, when second information is transmitted by the network device, the PUSCH corresponding to the CG is transmitted according to one or more TCI states. Alternatively, when the second information is not transmitted by the network device, the PUSCH corresponding to the CG is transmitted according to one TCI state.

In some embodiments, the communication unit 801 is further configured to transmit third information indicating activated TCI states available for uplink transmission. One or more TCI states of the activated TCI states available for the uplink transmission is used for the terminal device to transmit the PUSCH corresponding to the CG.

In some embodiments, when a first number of activated TCI states available for uplink transmission is less than or equal to a second number of TCI states for transmitting the PUSCH corresponding to the CG indicated by the second information, the PUSCH corresponding to the CG is transmitted according to the activated TCI states available for the uplink transmission. Alternatively, when the first number of the activated TCI states available for the uplink transmission is greater than the second number of the TCI states for transmitting the PUSCH corresponding to the CG indicated by the second information, the PUSCH corresponding to the CG is transmitted according to a third number of the activated TCI states available for the uplink transmission. The third number is less than or equal to the second number.

In some embodiments, when activated TCI states available for uplink transmission include a first TCI state, and a number of TCI states for transmitting the PUSCH corresponding to the CG indicated by the second information is one or more, the PUSCH corresponding to the CG is transmitted according to the first TCI state.

In some embodiments, the PUSCH corresponding to the CG is transmitted according to the first TCI state and a first SRS resource.

In some embodiments, the first SRS resource is indicated by srs-ResourceIndicator in an RRC parameter rrc-ConfiguredUplinkGrant. Alternatively, the first SRS resource is indicated by srs-ResourceIndicator2 in the RRC parameter rrc-ConfiguredUplinkGrant.

In some embodiments, the communication unit 801 is further configured to transmit fourth information.

The fourth information is configured to indicate that the first SRS resource is indicated by srs-ResourceIndicator in an RRC parameter rrc-ConfiguredUplinkGrant. Alternatively, the fourth information is configured to indicate that the first SRS resource is indicated by srs-ResourceIndicator2 in the RRC parameter rrc-ConfiguredUplinkGrant.

In some embodiments, the first SRS resource is determined by an SRS resource indication field in DCI. Alternatively, the first SRS resource is determined by a second SRS resource indication field in the DCI.

In some embodiments, the communication unit 801 is further configured to transmit fifth information.

The fifth information is configured to indicate that the first SRS resource is determined by an SRS resource indication field in DCI. Alternatively, the fifth information is configured to indicate that the first SRS resource is determined by a second SRS resource indication field in the DCI.

In some embodiments, the PUSCH corresponding to the CG is transmitted according to the first TCI state, the first SRS resource and the second SRS resource.

In some embodiments, an uplink transmission spatial filter or a spatial relation related to PUSCH transmission corresponding to the first SRS resource is determined according to the first TCI state, and an uplink transmission spatial filter or a spatial relation related to PUSCH transmission corresponding to the second SRS resource is determined according to the first TCI state.

In some embodiments, the communication unit 801 is further configured to transmit sixth information. The sixth information is configured to indicate that the PUSCH corresponding to the CG is transmitted according to the first TCI state and a first SRS resource. Alternatively, the sixth information is configured to indicate that the PUSCH corresponding to the CG is transmitted according to the first TCI state, the first SRS resource, and a second SRS resource.

In some embodiments, when activated TCI states available for uplink transmission include a first TCI state and a second TCI state, and a number of TCI states for transmitting the PUSCH corresponding to the CG indicated by the second information is one or more, the PUSCH corresponding to the CG is transmitted according to the first TCI state and the second TCI state.

In some embodiments, the PUSCH corresponding to the CG is transmitted according to the first TCI state, the second TCI state, a first SRS resource and a second SRS resource. The first SRS resource corresponds to the first TCI state, and the second SRS resource corresponds to the second TCI state.

In some embodiments, an uplink transmission spatial filter or a spatial relation related to PUSCH transmission corresponding to the first SRS resource is determined according to the first TCI state, and an uplink transmission spatial filter or a spatial relation related to PUSCH transmission corresponding to the second SRS resource is determined according to the second TCI state.

In some embodiments, the first SRS resource is indicated by srs-ResourceIndicator in an RRC parameter rrc-ConfiguredUplinkGrant, and the second SRS resource is indicated by srs-ResourceIndicator2 in the RRC parameter rrc-ConfiguredUplinkGrant.

In some embodiments, an SRS resource with a lesser identification of SRS resources indicated by SRS-ResourceIndicator and SRS-ResourceIndicator2 in an RRC parameter rrc-ConfiguredUplinkGrant is the first SRS resource, a SRS resource with a greater identification is the second SRS resource. Alternatively, an SRS resource with a greater identification is the first SRS resource, and an SRS resource with a lesser identification is the second SRS resource.

In some embodiments, the first SRS resource is determined by an SRS resource indication field in DCI, and the second SRS resource is determined by a second SRS resource indication field in the DCI.

In some embodiments, an SRS resource with a lesser identification of SRS resources indicated by an SRS resource indication field in DCI and by a second SRS resource indication field in the DCI is the first SRS resource, and an SRS resource with a greater identification is the second SRS resource. Alternatively, an SRS resource with a greater identification is the first SRS resource, and an SRS resource with a lesser identification is the second SRS resource.

In some embodiments, the first TCI state is a TCI state with a minimum identification of multiple activated TCI states available for the uplink transmission, and the second TCI state is a TCI state with a maximum identification or a second minimum identification of the multiple activated TCI states available for the uplink transmission. Alternatively, the first TCI state is a TCI state with the maximum identification of the multiple activated TCI states available for the uplink transmission, and the second TCI state is a TCI state with the minimum identification or a second maximum identification of the multiple activated TCI states available for the uplink transmission.

In some embodiments, the communication unit 801 is further configured to transmit seventh information. The first TCI state is a TCI state, of multiple activated TCI states available for the uplink transmission, at a foremost position of multiple TCI states indicated by the seventh information, and the second TCI state is a TCI state, of the multiple activated TCI states available for the uplink transmission, at a furthest position or a second foremost position of the multiple TCI states indicated by the seventh information. Alternatively, the first TCI state is a TCI state, of the multiple activated TCI states available for the uplink transmission, at the furthest position of the multiple TCI states indicated by the seventh information, and the second TCI state is a TCI state, of the multiple activated TCI states available for the uplink transmission, at the foremost position or a second furthest position of the multiple TCI states indicated by the seventh information.

In some embodiments, the communication unit 801 is further configured to transmit eighth information.

The eighth information is configured to indicate that the first TCI state is a TCI state with a minimum identification of multiple activated TCI states available for the uplink transmission and the second TCI state is a TCI state with a maximum identification or a second minimum identification of the multiple activated TCI states available for the uplink transmission. Alternatively, the eighth information is configured to indicate that the first TCI state is a TCI state with the maximum identification of the multiple activated TCI states available for the uplink transmission and the second TCI state is a TCI state with the minimum identification or a second maximum identification of the multiple activated TCI states available for the uplink transmission.

In some embodiments, the communication unit 801 is further configured to transmit ninth information.

The ninth information is configured to indicate that the first TCI state is a TCI state, of the multiple activated TCI states available for the uplink transmission, at a foremost position of multiple TCI states indicated by the seventh information received by the terminal device, and the first TCI state is a TCI state, of the multiple activated TCI states available for the uplink transmission, at a furthest position or a second foremost position of the multiple TCI states indicated by the seventh information. Alternatively, the ninth information is configured to indicate that the first TCI state is a TCI state, of the multiple activated TCI states available for the uplink transmission, at the furthest position of the multiple TCI states indicated by the seventh information received by the terminal device, and the first TCI state is a TCI state, of the multiple activated TCI states available for the uplink transmission, at the foremost position or a second furthest position of the multiple TCI states indicated by the seventh information.

In some embodiments, when the activated TCI states available for the uplink transmission include a first TCI state and a second TCI state, and a number of TCI states for transmitting the PUSCH corresponding to the CG indicated by the second information is one, the PUSCH corresponding to the CG is transmitted according to the first TCI state or the second TCI state.

In some embodiments, the PUSCH corresponding to the CG is transmitted according to a TCI state with a lesser identification of the first TCI state and the second TCI state, or the PUSCH corresponding to the CG is transmitted according to a TCI state with a greater identification of the first TCI state and the second TCI state, or the PUSCH corresponding to the CG is transmitted according to a more forward TCI state between the first TCI state and the second TCI state among multiple TCI states indicated by the seventh information received by the terminal device; or the PUSCH corresponding to the CG is transmitted according to a farther TCI state between the first TCI state and the second TCI state among the multiple TCI states indicated by the seventh information received by the terminal device.

In some embodiments, the communication unit 801 is further configured to transmit tenth information. The tenth information is configured to indicate that the PUSCH corresponding to the CG is transmitted according to a TCI state with a lesser identification of the first TCI state and the second TCI state. Alternatively, the tenth information is configured to indicate that the PUSCH corresponding to the CG is transmitted according to a TCI state with a greater identification of the first TCI state and the second TCI state.

In some embodiments, the communication unit 801 is further configured to transmit eleventh information. The eleventh information is configured to indicate that the PUSCH corresponding to the CG is transmitted according to a more forward TCI state between the first TCI state and the second TCI state among multiple TCI states indicated by the seventh information received by the terminal device. Alternatively, the eleventh information is configured to indicate that the PUSCH corresponding to the CG is transmitted according to a farther TCI state between the first TCI state and the second TCI state among the multiple TCI states indicated by the seventh information received by the terminal device.

In some embodiments, at least one of the fourth information, the fifth information, the sixth information, the eighth information, the ninth information, the tenth information or the eleventh information is transmitted by an RRC signaling, an MAC CE signaling or a DCI signaling.

In some embodiments, the seventh information is transmitted by an MAC CE signaling.

In some embodiments, an MAC CE signaling for transmitting the seventh information includes at least one of the following:
DL BWP indication information;
UL BWP indication information;
one or more TCI number indication fields. Each TCI number indication field indicates that one codepoint corresponds to one or more TCI states;
one or more TCI state type indication fields. Each TCI state type indication field indicates that a corresponding TCI state is a DL TCI state, a joint TCI state, or an UL TCI state; or
one or more pieces of TCI state indication information.

In some embodiments, the communication unit 801 is further configured to transmit twelfth information. The twelfth information is configured to indicate that a TCI state type includes a joint TCI state or a separate TCI state.

In some embodiments, the communication unit 801 is further configured to receive at least one of: first capability information, second capability information or third capability information. The first capability information is configured to indicate that the terminal device supports a fourth number of TCI states for uplink transmission or uplink repetition, or the first capability information is configured to indicate that the terminal device supports that a codepoint in a TCI field in DCI activates or indicates at most the fourth number of TCI states for the uplink transmission or the uplink repetition. The second capability information is configured to indicate that the terminal device supports transmitting the PUSCH corresponding to the CG. The third capability information is configured to indicate that the terminal device supports transmitting the PUSCH corresponding to the CG according to the fourth number of TCI states.

In some embodiments, the fourth number is 2 or 4.

In some embodiments, the network device receives the first capability information and the second capability information through a same signaling, or the network device receives the first capability information and the second capability information through different signaling.

In some embodiments, at least one of the first capability information, the second capability information, or the third capability information is transmitted through an RRC signaling or an MAC CE signaling.

In some embodiments, at least one of the first capability information, the second capability information or the third capability information is reported for a band, and/or is reported independently according to a band combination, and/or is reported independently according to each band in a band combination, and/or is reported independently according to each carrier on each band in a band combination, and/or is reported according to a FR, and/or is reported for the terminal device.

In some embodiments, the one or more TCI states are unified TCI states.

FIG. 9 is a structural diagram of a communication device according to an embodiment of the present disclosure. The communication device 900 may include one of a terminal device or a network device. The communication device 900 illustrated in FIG. 9 may include a processor 910 and a memory 920. The memory 920 is configured to store a computer program executable on the processor 910. The communication method in any of the above-described embodiments is implemented when the processor 910 executes the program.

Alternatively, the memory 920 may be a separate device independent of the processor 910 or may be integrated in the processor 910.

In some embodiments, as illustrated in FIG. 9, the communication device 900 may further include a transceiver 930. The processor 910 may control the transceiver 930 to communicate with other devices, and in particular, may transmit information or data to the other devices or receive information or data transmitted by the other devices.

The transceiver 930 may include a transmitter and a receiver. The transceiver 930 may further include one or more antennas.

In some embodiments, the communication device 900 may specifically be a terminal device or a network device according to an embodiment of the present disclosure, and the communication device 900 may be configured to implement corresponding processes implemented by the terminal device or the network device in various methods according to the embodiments of the present disclosure, which would not be described herein for the sake of brevity.

Embodiments of the present disclosure also provide a computer storage medium having stored thereon one or more programs. The one or more programs can be executed by one or more processors to implement the communication method in any embodiment of the present disclosure.

In some embodiments, the computer readable storage medium may be applied to the terminal device or the network device in the embodiments of the present disclosure, and the computer program causes the computer to execute corresponding processes implemented by the terminal device or the network device in various methods of the embodiments of the present disclosure, which would not be described herein for the sake of brevity.

FIG. 10 is a structural diagram of a chip according to an embodiment of the present disclosure. The chip 1000 illustrated in FIG. 10 includes a processor 1010. The processor 1010 is configured to invoke and run a computer program from a memory to implement the method according to any embodiment of the present disclosure.

In some embodiments, as illustrated in FIG. 10, the chip 1000 may further include a memory 1020. The processor 1010 may invoke and run a computer program from the memory 1020 to implement the methods in the embodiments of the present disclosure.

The memory 1020 may be a separate device independent of the processor 1010 or may be integrated in the processor 1010.

In some embodiments, the chip 1000 may further include an input interface 1030. The processor 1010 may control the input interface 1030 to communicate with other devices or chips, and in particular, may acquire information or data transmitted by other devices or chips.

In some embodiments, the chip 1000 may further include an output interface 1040. The processor 1010 may control the output interface 1040 to communicate with other devices or chips, and in particular, may output information or data to other devices or chips.

In some embodiments, the chip may be applied to the terminal device or the network device in the embodiments of the present disclosure, and the chip may implement corresponding processes implemented by the terminal device or the network device in various methods of the embodiments of the present disclosure, which would not be described herein for the sake of brevity.

It should be understood that the chip mentioned in the embodiments of the present disclosure may also be referred to as a system level chip, a system chip, a chip system, a system-on-chip, or the like.

Embodiments of the present disclosure also provide a computer program product including a computer storage medium. The computer storage medium is configured to store a computer program. The computer program includes instructions executable by at least one processor that, when executed by the at least one processor, implement the communication method according to any embodiment of the present disclosure.

In some embodiments, the computer program product may be applied to the terminal device or the network device in the embodiments of the present disclosure, and the computer program instructions cause the computer to execute corresponding processes implemented by the terminal device or the network device in various methods of the embodiments of the present disclosure, which would not be described herein for the sake of brevity.

Alternatively, the computer program product in the embodiment of the present disclosure may also be referred to as a software product in other embodiments.

Embodiment of the present disclosure further provides a computer program that causes a computer to execute the communication method according to any embodiment of the present disclosure.

In some embodiments, the computer program may be applied to the terminal device or the network device in the embodiments of the present disclosure. When the computer program is run on the computer, the computer executes corresponding processes implemented by the terminal device or the network device in various methods of the embodiments of the present disclosure, which would not be described herein for the sake of brevity.

The processor, the communication device, or the chip in the embodiments of the present disclosure may be an integrated circuit chip having signal processing capability. In the implementation process, the various operations of the above method embodiments may be accomplished by integrated logic circuitry of hardware in the processor or instructions in the form of software. The above-mentioned processor, communication device or chip may include the integration of any one or more of the following: a general purpose processor, an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a Graphics Processing Unit (GPU), neural-network processing units (NPU), a controller, a microcontroller, a microprocessor, a programmable logic device, a discrete gate, a transistor logic device or discrete hardware components. The methods, operations and logic block diagrams disclosed in the embodiments of the present disclosure may be implemented or performed. The general purpose processor may be a microprocessor or the processor may be any conventional processor or the like. The operations of the methods disclosed in combination with the embodiments of the present disclosure may be directly embodied as the execution of the hardware decoding processor or the combined execution of the hardware and software modules in the decoding processor. The software module may be located in a Random Access Memory (RAM), a flash memory, a Read-Only Memory (ROM), a Programmable ROM (PROM), an electrically erasable PROM (EEPROM), a register and other storage medium mature in the art. The storage medium is located in the memory, and the processor reads the information in the memory and completes the operations of the methods in combination with its hardware.

It is understood that the memory or computer storage medium in embodiments of the present disclosure may be a volatile memory or a non-volatile memory or may include both the volatile memory and the non-volatile memory. The non-volatile memory may be a ROM, a PROM, an Erasable PROM (EPROM), an EEPROM or a flash memory. The volatile memory may be a RAM which serves as an external cache. By way of illustration, but not limitation, many forms of RAM are available, such as a static RAM (SRAM), a Dynamic RAM (DRAM), a Synchronous DRAM (SDRAM), Double Data Rate SDRAM (DDR SDRAM), an Enhanced SDRAM (ESDRAM), an Synchlink DRAM (SLDRAM) and a Direct Rambus RAM (DR RAM). It should be noted that the memory of the systems and methods described herein is intended to include but is not limited to these and any other suitable types of memory.

It should be understood that the above memory or computer storage medium is an exemplary but not limiting example. For example, the memory in the embodiments of the present disclosure may also be an SRAM, a DRAM, an SDRAM, a DDR SDRAM, an ESDRAM, an SLDRAM, a DR RAM, etc. That is, the memory in the embodiments of the present disclosure is intended to include but is not limited to these and any other suitable types of memories.

Those of ordinary skill in the art will be appreciated that the various exemplary units and algorithm operations described in combination with the embodiments disclosed herein may be implemented in electronic hardware or a combination of computer software and electronic hardware. Whether these functions are performed in hardware or software depends on the specific application and design constraints of the technical solutions. Those skilled may use different methods for each particular application to implement the described functionality, but such implementation should not be considered beyond the scope of the present disclosure.

Those skilled in the art would clearly appreciate that, for convenience and conciseness of description, the specific operating processes of the above described systems, apparatuses and units may refer to the corresponding processes in the aforementioned method embodiments, which would not be repeated here for the sake of brevity.

In several embodiments provided herein, it should be understood that the disclosed systems, apparatuses and methods may be implemented in other ways. For example, the above embodiments of the apparatuses are only schematic. For example, the division of the units is only a logical function division, and in practice, there may be other division modes. For example, multiple units or components may be combined or integrated into another system, or some features may be ignored or not performed. On the other hand, the coupling, direct coupling or communication connection between each other shown or discussed may be indirect coupling or communication connection through some interfaces, apparatuses or units, and may be electrical, mechanical or other form.

The units illustrated as separate components may be or may not be physically separated, and the components displayed as units may be or may not be physical units. That is, they may be located in one place, or may be distributed over multiple network units. Part or all of the units may be selected according to the actual requirements to achieve the purpose of the embodiments.

In addition, various functional units in various embodiments of the present disclosure may be integrated into one processing unit, or various units may exist physically alone, or two or more units may be integrated in one unit.

The functions may be stored in a computer readable storage medium if implemented in the form of software functional units and sold or used as stand-alone products. Based on such understanding, the technical solution of the present disclosure in essence or in the part contributing to the prior art may be embodied in the form of a software product. The computer software product is stored in a storage medium, which includes several instructions for causing a computer device (which may be a personal computer, a server, a network device etc.,) to perform all or part of the operations of the methods described in various embodiments of the present disclosure. The above storage medium includes a U disk, a removable hard disk, a ROM, a RAM, a magnetic disk or an optical disk and other medium capable of storing program codes.

The above-mentioned is only the specific embodiments of the present disclosure, but the scope of protection of the present disclosure is not limited thereto. Any changes or replacements that can be easily thought of by those skilled in the art within the scope of the technology disclosed in the present disclosure should be included in the scope of protection of the present disclosure. Therefore, the scope of protection of the present disclosure shall be subject to the scope of protection of the claims.

1. A communication method, comprising:
transmitting, by a terminal device, a Physical Uplink Shared Channel (PUSCH) corresponding to a Configured Grant (CG) according to one or more Transmission Configuration Indication (TCI) states.

2. The method of claim 1, further comprising:
receiving, by the terminal device, first information indicating the CG.

3. The method of claim 1, further comprising:
receiving, by the terminal device, second information indicating that the PUSCH corresponding to the CG is transmitted according to one or more TCI states.

4. The method of claim 3, wherein the second information being of a first value indicates that the PUSCH corresponding to the CG is transmitted according to one TCI state; or
the second information being of a second value indicates that the PUSCH corresponding to the CG is transmitted according to one or more TCI states.

5. The method of claim 1, further comprising:
receiving, by the terminal device, third information indicating activated TCI states available for uplink transmission,
wherein transmitting, by the terminal device, the PUSCH corresponding to the CG according to the one or more TCI states comprises:
transmitting, by the terminal device, the PUSCH corresponding to the CG according to one or more TCI states of the activated TCI states available for the uplink transmission.

6. The method of claim 3, wherein transmitting, by the terminal device, the PUSCH corresponding to the CG according to the one or more TCI states comprises:
when activated TCI states available for uplink transmission comprise a first TCI state and a second TCI state, and a number of TCI states for transmitting the PUSCH corresponding to the CG indicated by the second information is one or more, transmitting, by the terminal device, the PUSCH corresponding to the CG according to the first TCI state and the second TCI state.

7. The method of claim 3, wherein transmitting, by the terminal device, the PUSCH corresponding to the CG according to the one or more TCI states comprises:
when activated TCI states available for uplink transmission comprise a first TCI state and a second TCI state, and a number of TCI states for transmitting the PUSCH corresponding to the CG indicated by the second information is one, transmitting, by the terminal device, the PUSCH corresponding to the CG according to the first TCI state or the second TCI state.

8. A terminal device, comprising:
a processor; and
a memory,
wherein the memory is configured to store a computer program executable on the processor, and
when executing the computer program, the processor is configured to, perform:
transmitting a Physical Uplink Shared Channel (PUSCH) corresponding to a Configured Grant (CG) according to one or more Transmission Configuration Indication (TCI) states.

9. The terminal device of claim 8, wherein when executing the computer program, the processor is further configured to perform:
receiving first information indicating the CG.

10. The terminal device of claim 8, wherein when executing the computer program, the processor is further configured to perform:
receiving second information indicating that the PUSCH corresponding to the CG is transmitted according to one or more TCI states.

11. The terminal device of claim 10, wherein when executing the computer program, the processor is specifically configured to perform:
when activated TCI states available for uplink transmission comprise a first TCI state and a second TCI state, and a number of TCI states for transmitting the PUSCH corresponding to the CG indicated by the second information is one or more, transmitting the PUSCH corresponding to the CG according to the first TCI state and the second TCI state.

12. The terminal device of claim 11, wherein when executing the computer program, the processor is specifically configured to perform:
transmitting, the PUSCH corresponding to the CG according to the first TCI state, the second TCI state, a first Sounding Reference Signal (SRS) resource and a second SRS resource,
wherein the first SRS resource corresponds to the first TCI state, and the second SRS resource corresponds to the second TCI state.

13. The terminal device of claim 12, wherein an uplink transmission spatial filter or a spatial relation related to PUSCH transmission corresponding to the first SRS resource is determined according to the first TCI state; and
an uplink transmission spatial filter or a spatial relation related to PUSCH transmission corresponding to the second SRS resource is determined according to the second TCI state.

14. The terminal device of claim 12, wherein the first SRS resource is indicated by srs-ResourceIndicator in a Radio Resource Control (RRC) parameter rrc-ConfiguredUplinkGrant; and
the second SRS resource is indicated by srs-ResourceIndicator2 in the RRC parameter rrc-ConfiguredUplinkGrant.

15. A network device, comprising:
a processor; and
a memory,
wherein the memory is configured to store a computer program executable on the processor, and
when executing the computer program, the processor is configured to perform:
receiving a Physical Uplink Shared Channel (PUSCH) corresponding to a Configured Grant (CG), wherein the PUSCH corresponding to the CG is transmitted according to one or more Transmission Configuration Indication (TCI) states.

16. The network device of claim 15, wherein when executing the computer program, the processor is further configured to perform:
transmitting first information indicating the CG.

17. The network device of claim 15, wherein when executing the computer program, the processor is further configured to perform:
transmitting second information indicating that the PUSCH corresponding to the CG is transmitted according to one or more TCI states.

18. The network device of claim 17, wherein the second information being of a first value indicates that the PUSCH corresponding to the CG is transmitted according to one TCI state; or
the second information being of a second value indicates that the PUSCH corresponding to the CG is transmitted according to one or more TCI states.

19. The network device of claim 17, wherein when executing the computer program, the processor is further configured to perform:
transmitting third information indicating activated TCI states available for uplink transmission, wherein one or more TCI states of the activated TCI states available for the uplink transmission is used for a terminal device to transmit the PUSCH corresponding to the CG.

20. The network device of claim 17, wherein when activated TCI states available for uplink transmission comprise a first TCI state and a second TCI state, and a number of TCI states for transmitting the PUSCH corresponding to the CG indicated by the second information is one or more, the PUSCH corresponding to the CG is transmitted according to the first TCI state and the second TCI state.
